(19) United States
(12) Patent Application Publication
(10) Pub. No.: US 2026/0369277 A1
(43) Pub. Date: Nov. 19, 2026

(54) SINGER IDENTIFICATION IN REAL AND DEEPFAKE RECORDINGS

(71) Applicant: MUSIC IP HOLDINGS, INC., NASHVILLE, TN (US)

(72) Inventors: ELIO QUINTON, Nashville, TN (US); HENDRIK VINCENT KOOPS, Nashville, TN (US); DAVIDE SALVI, Nashville, TN (US)

(21) Appl. No.: 19/679,041

(22) Filed: May 15, 2026

Related U.S. Application Data
(60) Provisional application No. 63/807,811, filed on May 18, 2025.

(51) Int. Cl. G10L 17/06; G06F 21/64; G10L 17/02; G10L 17/04; G10L 17/18; G10L 25/18; G10L 25/45; G10L 25/81

(52) U.S. Cl. CPC G10L 17/06; G06F 21/64; G10L 17/02; G10L 17/04; G10L 17/18; G10L 25/18; G10L 25/45; G10L 25/81

(57) ABSTRACT

A two-stage pipeline identifies a singer in an audio recording that may contain authentic or synthetically generated vocal signals. A deepfake detection model classifies the audio recording as authentic or synthetically generated. Audio recordings classified as synthetically generated are excluded from a singer identification process. For audio recordings classified as authentic, a singer identification model generates an embedding based on a vocal signal contained in the audio recording. A respective distance metric is computed between the embedding and each of a plurality of reference embeddings, each reference embedding associated with a respective singer. The respective singer whose associated reference embedding provides a smallest distance metric relative to the embedding is identified as a singer associated with the audio recording. The pipeline supports content authenticity verification, vocal likeness protection, rights management, and royalty allocation in audio content ecosystems containing both authentic and synthetic audio recordings.

### CROSS-REFERENCE TO RELATED APPLICATIONS

This Application claims the benefit of and priority to U.S. Provisional Patent Application No. 63/807,811, filed on May 18, 2025, the entire contents of which are hereby incorporated by reference.

### BACKGROUND

### Field

Aspects of the present disclosure relate to audio signal processing, and more particularly, but not exclusively, to machine learning systems for analyzing audio recordings.

### Description of Related Art

Recent advances in machine learning and audio synthesis have enabled the generation of highly realistic synthetic audio signals. Voice cloning models have reached a level of fidelity at which generated singing voice recordings can closely replicate the timbre, inflection, and stylistic characteristics of a target vocalist. Such models typically accept text, melody, reference audio, or some combination thereof as input, and produce output recordings that, in many cases, are difficult for a human listener to distinguish from authentic recordings of the targeted vocalist. Recordings of this type are commonly referred to as singing voice deepfakes.

The proliferation of singing voice deepfakes presents concerns for content authenticity, vocalist likeness protection, intellectual property enforcement, and monetization of recorded music. Unauthorized synthetic recordings may be distributed across streaming services, social media platforms, and other channels in a manner that misappropriates the vocal identity of a recording artist, exposes that artist to reputational harm, and dilutes the commercial value of authentic content. The risks associated with such recordings vary with the perceptual quality of the synthesized output. Lower quality synthesis may contain audible artifacts, unnatural prosody, or other deficiencies that limit its capacity to deceive a listener, while higher quality synthesis may produce output that is largely indistinguishable from authentic content and therefore presents a comparatively greater risk of misuse.

### SUMMARY

Certain aspects provide a computer-implemented method for identifying a singer in an audio recording. The method generally includes receiving, by one or more processors, an audio recording. The method further generally includes generating a classification of the audio recording as one of authentic or synthetically generated by applying a deepfake detection model to the audio recording. The method further generally includes, in response to the classification indicating that the audio recording is synthetically generated, excluding the audio recording from a singer identification process. The method further generally includes, in response to the classification indicating that the audio recording is authentic, generating, using a singer identification model and based on a vocal signal contained in the audio recording, an embedding; computing a respective distance metric between the embedding and each of a plurality of reference embeddings, each reference embedding being associated with a respective singer; and identifying, as a singer associated with the audio recording, the respective singer whose associated reference embedding provides a smallest distance metric relative to the embedding.

Other aspects provide processing systems configured to perform the aforementioned methods as well as those described herein; non-transitory, computer-readable media comprising instructions that, when executed by a processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### DESCRIPTION OF THE DRAWINGS

The appended figures depict certain aspects and are therefore not to be considered limiting of the scope of this disclosure.

FIG. 1 is a block diagram illustrating a two-stage pipeline for singer identification in audio recordings, in accordance with aspects of the present disclosure.

FIG. 2 is a flowchart illustrating a method for identifying a singer in an audio recording, in accordance with aspects of the present disclosure.

FIG. 3 is a block diagram illustrating an audio pre-processing pipeline, in accordance with aspects of the present disclosure.

FIG. 4 is a block diagram illustrating an architecture of a deepfake detection model and an architecture of a singer identification model, in accordance with aspects of the present disclosure.

FIG. 5 is a block diagram illustrating a training process for a singer identification model, in accordance with aspects of the present disclosure.

FIG. 6 is a block diagram illustrating a windowed inference procedure, in accordance with aspects of the present disclosure.

FIG. 7 is a diagram illustrating example performance characteristics of a deepfake detection model, in accordance with aspects of the present disclosure.

FIG. 8 is a block diagram illustrating a downstream action workflow initiated in response to classification of an audio recording as synthetically generated by a deepfake detection model, in accordance with aspects of the present disclosure.

FIG. 9 is a block diagram illustrating a computing environment in which a two-stage pipeline for singer identification can be implemented, in accordance with aspects of the present disclosure.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer-readable mediums for identifying a singer associated with an audio recording in a content environment that includes both authentic audio recordings and synthetically generated audio recordings.

Recent advances in voice cloning and audio synthesis have made it possible to generate highly realistic audio recordings of vocal performances that closely replicate the timbre, inflection, and stylistic characteristics of a target vocalist. Audio recordings of this kind, sometimes referred to as singing voice deepfakes, can be difficult for a human listener to distinguish from authentic recordings of the targeted vocalist. The proliferation of such audio recordings across streaming services, social media platforms, and other distribution channels presents practical concerns for content authenticity, vocalist likeness protection, intellectual property enforcement, and royalty allocation. A singer identification system that can attribute an audio recording to a particular vocalist would, in principle, support these concerns by enabling automated attribution, rights management, and content moderation workflows. Existing singer identification approaches, however, have generally been developed using corpora of authentic recordings, and their behavior degrades when applied to data that contains a mixture of authentic recordings and synthetic recordings of varying perceptual quality. The present disclosure addresses this degradation by separating the audio recordings that a singer identification model operates on from the audio recordings that are unsuitable for such operation, using a dedicated upstream classification stage to perform the separation.

One technical problem that arises in singer identification under realistic content conditions is that synthetically generated audio recordings degrade the accuracy of singer identification models that were trained on authentic data. The degradation may not be uniform across synthetic audio recordings. Lower-quality synthetic audio recordings may fail to preserve vocal characteristics that the singer identification model relies on for attribution, which can cause the model to produce embeddings that do not correspond meaningfully to any singer. Higher-quality synthetic audio recordings preserve such characteristics more faithfully, which means the singer identification model can still produce useful embeddings from them, but at the same time these higher-quality synthetic audio recordings are precisely the audio recordings that are most difficult to detect as synthetic. A further technical problem is that conventional approaches to filtering audio recordings have tended to either filter too aggressively, causing authentic audio recordings to be improperly excluded from singer identification, or filter too leniently, causing low-quality synthetic audio recordings to flow through and corrupt downstream singer identification results. Designing a single end-to-end model to handle both deepfake detection and singer identification simultaneously has proven difficult because the two tasks have different objectives and operate well on different model architectures.

To address these problems, aspects of the present disclosure provide a two-stage pipeline that combines a deepfake detection model with a singer identification model in a specific functional arrangement. The deepfake detection model may operate first as a filter on incoming audio recordings, generating a classification of each audio recording as authentic or synthetically generated. Audio recordings classified as synthetically generated are excluded from the singer identification process, while audio recordings classified as authentic are passed through to the singer identification model. The singer identification model then generates an embedding from a vocal signal contained in the audio recording, and a nearest-neighbor search compares the embedding against a plurality of reference embeddings, each associated with a respective singer, to identify a singer associated with the audio recording. The deepfake detection model is configured such that it reliably detects lower-quality synthetic audio recordings while allowing higher-quality synthetic audio recordings to pass through. This configuration choice exploits a useful asymmetry: lower-quality synthetic audio recordings degrade singer identification accuracy and provide little useful signal, so excluding them improves overall performance, while higher-quality synthetic audio recordings preserve enough vocal characteristics that the singer identification model can still operate meaningfully on them, and indeed should operate on them because they pose the greatest risk of misuse. In some aspects, the pipeline further includes audio pre-processing operations that isolate a vocal signal from background music and remove non-vocal segments before classification or embedding generation. In some aspects, the pipeline further includes a windowed inference operation that extracts multiple time windows from the audio recording, generates a per-window embedding for each time window, and averages the per-window embeddings to produce a more robust embedding. In some aspects, the pipeline further includes a downstream action workflow that initiates one or more content authenticity actions in response to a synthetic classification, such as generating an alert, transmitting a notification to a rights holder, flagging the audio recording for review, removing the audio recording from a distribution platform, or recording an entry in a content authenticity log.

The disclosed two-stage pipeline produces several concrete technical effects. By filtering out lower-quality synthetic audio recordings before they reach the singer identification model, the pipeline may reduce the rate at which the singer identification model operates on audio recordings whose vocal characteristics do not correspond to any actual singer, which may directly improve the accuracy of singer identification under realistic mixed-content conditions. Empirical evaluation across multiple content datasets shows substantial improvements in standard singer identification metrics, including reductions in equal error rate and increases in area under the receiver operating characteristic curve, relative to a baseline configuration in which singer identification is performed without the upstream filtering stage. The pipeline may also reduce computational waste by excluding audio recordings classified as synthetically generated from downstream embedding generation and nearest-neighbor search operations, which can lower the average computational cost per audio recording processed at scale. The audio pre-processing operations may further improve accuracy by ensuring that the deepfake detection model and the singer identification model operate on vocal content rather than on background music or non-vocal segments, which improves the discriminative power of both models. The windowed inference operation may further improve accuracy of the resulting embedding by aggregating embedding information across multiple time windows of the audio recording, which reduces sensitivity of the resulting embedding to localized variations such as transient noise or momentary changes in vocal characteristics. The downstream action workflow may further extend the technical effect of the pipeline beyond classification and identification, by enabling automated content authenticity, rights management, and content moderation actions that would otherwise require manual review of each audio recording. Collectively, these technical effects may support the deployment of the pipeline in practical content ecosystems where authentic and synthetic audio recordings coexist, and where reliable singer attribution and content authenticity verification are operationally important.

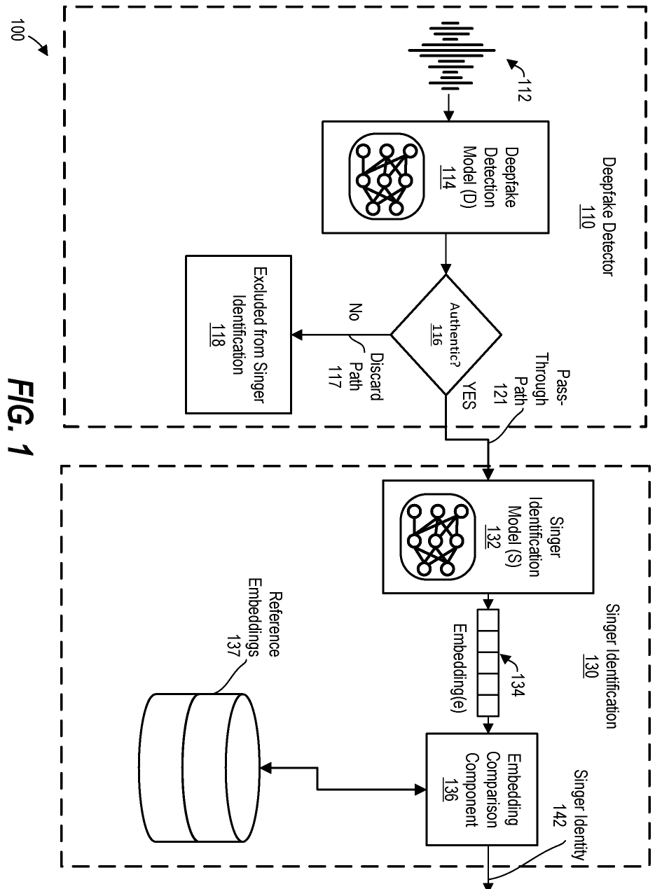

FIG. 1 illustrates a two-stage pipeline 100 for identifying a singer in an audio recording in accordance with aspects of the present disclosure. The two-stage pipeline 100 may include a deepfake detector 110 and a singer identification stage 130. The deepfake detector 110 may classify the audio recording as authentic or synthetically generated. The singer identification stage 130 may identify a singer associated with the audio recording when the audio recording is classified as authentic. Thus, the two-stage pipeline 100 may improve singer identification accuracy by filtering audio recordings that are classified as synthetically generated before such audio recordings reach the singer identification stage 130.

The deepfake detector 110 may receive an audio recording 112. The audio recording 112 may include a vocal signal. A vocal signal may refer to a signal that contains a representation of a human voice, such as a singing voice, a spoken voice, a rapping voice, or a humming voice. The audio recording 112 may be received from a streaming service, a social media platform, a content delivery network, a local file system, or another audio source. In some aspects, the audio recording 112 may include background music in addition to the vocal signal. Additionally, or alternatively, the audio recording 112 may include only a vocal signal.

The deepfake detector 110 may apply a deepfake detection model 114 to the audio recording 112. The deepfake detection model 114 may refer to a machine learning model trained to classify audio recordings as authentic or synthetically generated. For example, the deepfake detection model 114 may include a convolutional neural network, a recurrent neural network, a transformer, or another type of neural network. In some aspects, the deepfake detection model 114 may include a Light Convolutional Neural Network (LCNN). The deepfake detection model 114 may operate on a spectral domain representation of the audio recording 112, such as a mel-spectrogram, a constant-Q transform, or a short-time Fourier transform. The deepfake detection model 114 may generate a classification of the audio recording 112 based on the spectral domain representation.

The deepfake detector 110 may provide the classification to a decision element 116. The decision element 116 may route the audio recording 112 based on the classification. For example, the decision element 116 may route the audio recording 112 along a discard path 117 when the classification indicates that the audio recording 112 is synthetically generated. Additionally, or alternatively, the decision element 116 may route the audio recording 112 along a pass-through path 121 when the classification indicates that the audio recording 112 is authentic.

The discard path 117 may lead to a discard block 118. The discard block 118 may exclude the audio recording 112 from a singer identification process performed by the singer identification stage 130. For example, the discard block 118 may delete the audio recording 112, flag the audio recording 112 for human review, store the audio recording 112 in a quarantine data store, transmit a notification to a rights holder, and/or generate an alert identifying the audio recording 112 as synthetically generated. Thus, the two-stage pipeline 100 may reduce computational waste by excluding low-quality synthetic audio recordings from downstream processing, and may further support content authenticity workflows by routing such audio recordings to appropriate downstream actions.

The pass-through path 121 may lead from the deepfake detector 110 to the singer identification stage 130. The singer identification stage 130 may receive the audio recording 112 by way of the pass-through path 121. In some aspects, audio recordings that traverse the pass-through path 121 may include high-quality synthetic audio recordings that are not detected by the deepfake detection model 114, in addition to authentic audio recordings. The singer identification stage 130 may operate on such audio recordings to identify a singer associated with each such audio recording.

The singer identification stage 130 may apply a singer identification model 132 to the audio recording 112. The singer identification model 132 may refer to a machine learning model trained to generate an embedding based on a vocal signal contained in an audio recording. An embedding may refer to a vector representation of features extracted from an input by a machine learning model, where the vector representation occupies a position in an embedding space. For example, the singer identification model 132 may include a time-delay neural network with channel attention, such as an ECAPA-TDNN. Additionally, or alternatively, the singer identification model 132 may include a self-supervised learning encoder, a residual network combined with a time-delay neural network, or another type of neural network suitable for generating embeddings from vocal signals.

The singer identification model 132 may generate an embedding 134 based on the vocal signal contained in the audio recording 112. The embedding 134 may be extracted from a layer of the singer identification model 132, such as a last dense layer of the singer identification model 132. In some aspects, the embedding 134 may be generated by extracting a plurality of time windows from the audio recording 112, generating a respective per-window embedding for each time window using the singer identification model 132, and averaging the per-window embeddings to produce the embedding 134. For example, the plurality of time windows may include five equidistant time windows, each time window having a duration of approximately ten seconds. Thus, the singer identification stage 130 may reduce sensitivity of the embedding 134 to localized variations in the audio recording 112 by averaging across multiple time windows of the audio recording 112.

The singer identification stage 130 may provide the embedding 134 to an embedding comparison component 136, such as a nearest-neighbor search component. An embedding comparison component may refer to a component that compares an embedding against a plurality of reference embeddings to identify one or more reference embeddings that are most similar to the embedding. The embedding comparison component 136 may compute a respective distance metric between the embedding 134 and each of a plurality of reference embeddings 137. A reference embedding may refer to an embedding previously generated from a vocal signal of a singer, where the reference embedding may be associated with the singer. The plurality of reference embeddings 137 may be stored in a data store, such as a database, a vector store, and/or a file system. In some aspects, the plurality of reference embeddings 137 may be generated by applying the singer identification model 132 to vocal signals of a plurality of singers prior to operation of the two-stage pipeline 100.

The embedding comparison component 136 may compute the distance metric based on a distance function. For example, the distance function may include a cosine distance, a Euclidean distance, a dot-product similarity, and/or a learned distance function. In some aspects, the distance function may include a cosine distance between the embedding 134 and a reference embedding of the plurality of reference embeddings 137. The embedding comparison component 136 may identify a smallest distance metric among the computed distance metrics. In some aspects, the embedding comparison component 136 may include a nearest-neighbor search component, an approximate nearest-neighbor search component, a vector similarity search component, an indexed vector search component (such as a search component using a hierarchical navigable small world graph, an inverted file index, or a product quantization index), a brute-force comparison component, and/or another component configured to compare embeddings against reference embeddings based on a distance function.

The embedding comparison component 136 may output a singer identity 142 based on the smallest distance metric. For example, the embedding comparison component 136 may identify, as the singer associated with the audio recording 112, the respective singer whose associated reference embedding provides the smallest distance metric relative to the embedding 134. The singer identity 142 may include a name of the singer, an identifier associated with the singer, a confidence score, and/or a combination thereof. Thus, the two-stage pipeline 100 may attribute the audio recording 112 to a singer based on a comparison of the embedding 134 to the plurality of reference embeddings 137 in the embedding space.

In some aspects, the singer identification model 132 may be trained such that embeddings generated from vocal signals of a same singer cluster more closely in the embedding space than embeddings generated from vocal signals of different singers. For example, the singer identification model 132 may be trained using a loss function that encourages clustering of embeddings from a same singer, such as an additive margin softmax loss, a contrastive loss, and/or a triplet loss. Thus, the embedding comparison component 136 may produce accurate singer identifications by leveraging the structure of the embedding space learned by the singer identification model 132.

In some aspects, the deepfake detection model 114 and the singer identification model 132 may be trained independently of one another. For example, the deepfake detection model 114 may be trained on a first training dataset that includes both authentic and synthetically generated audio recordings, and the singer identification model 132 may be trained on a second training dataset that includes authentic audio recordings of a plurality of singers. Additionally, or alternatively, the deepfake detection model 114 and the singer identification model 132 may be trained jointly. Thus, the two-stage pipeline 100 may accommodate independently trained or jointly trained models based on training data availability and deployment constraints.

In some aspects, the deepfake detection model 114 and the singer identification model 132 may be implemented as separable output heads of a single unified neural network rather than as two structurally separate models. For example, the unified neural network may receive a vocal signal contained in the audio recording 112 as input and may produce a classification output indicating that the audio recording 112 is authentic or synthetically generated, and an embedding output representative of the vocal signal contained in the audio recording 112. The classification output may be produced by a classification head of the unified neural network, and the embedding output may be produced by an embedding head of the unified neural network. The classification head and the embedding head may share one or more layers of the unified neural network, such as one or more convolutional layers, recurrent layers, attention layers, or transformer layers. In some aspects, downstream processing of the embedding output may be conditioned on the classification output, such that the embedding output is provided to the embedding comparison component 136 in response to the classification output indicating that the audio recording 112 is authentic, and is excluded from such provision in response to the classification output indicating that the audio recording 112 is synthetically generated. Thus, the two-stage pipeline 100 may be implemented as a unified neural network architecture with separable classification and embedding output heads, while preserving the conditional gating of downstream processing on the classification output.

In some aspects, the conditional gating of downstream processing may be implemented as a continuous-confidence weighting rather than a binary exclusion. For example, the deepfake detection model 114 may produce a classification confidence score indicating a likelihood that the audio recording 112 is authentic, and the singer identification stage 130 may weight a contribution of the embedding 134 to a final identification result by a function of the classification confidence score. The function may include a linear weighting, a sigmoid weighting, a threshold-with-soft-floor weighting, and/or another weighting function. In some aspects, the embedding 134 may be provided to the embedding comparison component 136 regardless of the classification confidence score, and the resulting distance metrics may be weighted by a function of the classification confidence score before identifying a singer associated with the audio recording 112. Additionally, or alternatively, the contribution of the embedding 134 to a confidence score associated with the identified singer may be weighted by a function of the classification confidence score. Thus, the two-stage pipeline 100 may employ a continuous-confidence weighting in place of, or in combination with, binary exclusion of audio recordings classified as synthetically generated.

As indicated above, FIG. 1 is provided as an example. Other examples may differ from what is described with regard to FIG. 1.

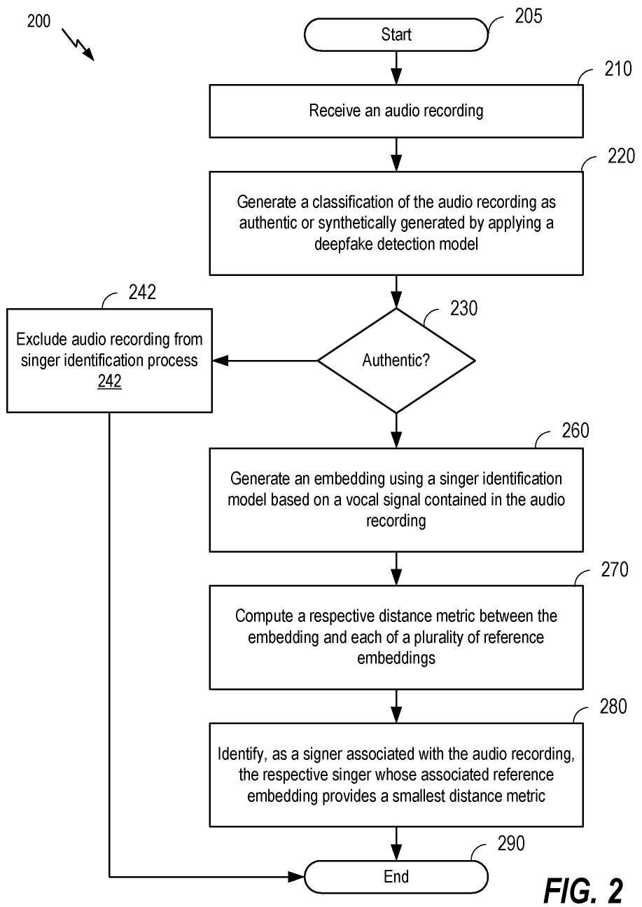

FIG. 2 illustrates a flowchart of a method 200 for identifying a singer in an audio recording in accordance with aspects of the present disclosure. The method 200 may be performed by a system that includes one or more processors and one or more non-transitory computer-readable media. For example, the method 200 may be performed by a content authenticity system, a rights management system, a streaming platform, a content delivery network, a social media platform, and/or another system that processes audio recordings. Thus, the system may identify a singer associated with an audio recording by performing the operations of the method 200, while excluding audio recordings that are classified as synthetically generated from a singer identification process.

The method 200 may begin at a start operation 205. The start operation 205 may correspond to initialization of the method 200. For example, the system may initialize the method 200 in response to receipt of an audio recording from an audio source, in response to a scheduled batch processing event, in response to a user request, and/or in response to another triggering condition. The system may proceed from the start operation 205 to a receive operation 210.

The system may receive an audio recording at the receive operation 210. An audio recording may refer to a representation of an audio signal, where the audio signal includes a vocal signal. For example, the audio recording may be received as a file, a stream, a buffer, or another data structure that represents the audio signal. In some aspects, the audio recording may be received from a streaming service, a social media platform, a content delivery network, a local file system, a microphone input, or another audio source. Additionally, or alternatively, the audio recording may be received as part of a batch of audio recordings to be processed by the method 200. The system may proceed from the receive operation 210 to a classify operation 220.

The system may generate a classification of the audio recording as authentic or synthetically generated by applying a deepfake detection model at the classify operation 220. The deepfake detection model may refer to a machine learning model trained to classify audio recordings as authentic or synthetically generated. For example, the deepfake detection model may include a convolutional neural network, such as a Light Convolutional Neural Network (LCNN). Additionally, or alternatively, the deepfake detection model may include a recurrent neural network, a transformer, and/or another type of neural network suitable for audio classification. In some aspects, the deepfake detection model may operate on a spectral domain representation of the audio recording, such as a mel-spectrogram. The classification may indicate that the audio recording is authentic or that the audio recording is synthetically generated. The system may proceed from the classify operation 220 to a decision operation 230.

The system may evaluate the classification at the decision operation 230. The decision operation 230 may route the audio recording based on the classification. For example, the system may proceed along a discard path when the classification indicates that the audio recording is synthetically generated. Additionally, or alternatively, the system may proceed along a pass-through path when the classification indicates that the audio recording is authentic. Thus, the system may conditionally route the audio recording based on the classification, which improves accuracy of downstream singer identification by filtering audio recordings that are classified as synthetically generated.

The system may exclude the audio recording from a singer identification process at an exclude operation 242 in response to the classification indicating that the audio recording is synthetically generated. The exclude operation 242 may include any action that prevents the audio recording from being processed by the singer identification operations of the method 200. For example, the system may delete the audio recording, flag the audio recording for human review, store the audio recording in a quarantine data store, transmit a notification to a rights holder, and/or generate an alert identifying the audio recording as synthetically generated. Additionally, or alternatively, the system may record an entry in a content authenticity log identifying the audio recording as synthetically generated. The system may proceed from the exclude operation 242 to an end operation 290. Thus, the system may reduce computational waste by excluding audio recordings classified as synthetically generated from downstream singer identification processing and may further support content authenticity workflows by routing such audio recordings to appropriate downstream actions.

The system may generate an embedding using a singer identification model at a generate embedding operation 260 in response to the classification indicating that the audio recording is authentic. The singer identification model may refer to a machine learning model trained to generate an embedding based on a vocal signal contained in an audio recording. An embedding may refer to a vector representation of features extracted from an input by a machine learning model, where the vector representation occupies a position in an embedding space. For example, the singer identification model may include a time-delay neural network with channel attention, such as an ECAPA-TDNN. Additionally, or alternatively, the singer identification model may include a self-supervised learning encoder, a residual network combined with a time-delay neural network, and/or another type of neural network suitable for generating embeddings from vocal signals. In some aspects, the singer identification model may be trained such that embeddings generated from vocal signals of a same singer cluster more closely in the embedding space than embeddings generated from vocal signals of different singers. The system may proceed from the generate embedding operation 260 to a compute distance operation 270.

The system may compute a respective distance metric between the embedding and each of a plurality of reference embeddings at the compute distance operation 270. A reference embedding may refer to an embedding previously generated from a vocal signal of a singer, where the reference embedding is associated with the singer. The plurality of reference embeddings may be stored in a data store, such as a database, a vector store, or a file system. The distance metric may be computed based on a distance function. For example, the distance function may include a cosine distance, a Euclidean distance, a dot-product similarity, and/or a learned distance function. In some aspects, the distance function may include a cosine distance between the embedding and a reference embedding of the plurality of reference embeddings. The system may proceed from the compute distance operation 270 to an identify singer operation 280.

The system may identify a singer associated with the audio recording at the identify singer operation 280. For example, the system may identify, as the singer associated with the audio recording, the respective singer whose associated reference embedding provides a smallest distance metric relative to the embedding. The smallest distance metric may refer to the distance metric having the lowest value among the distance metrics computed at the compute distance operation 270. In some aspects, the system may output the identified singer as a singer identity, where the singer identity may include a name of the singer, an identifier associated with the singer, a confidence score, and/or a combination thereof. Additionally, or alternatively, the system may output the singer identity to a downstream system, such as a rights management system, a royalty allocation system, a content authenticity verification system, and/or another system that consumes singer identity information. The system may proceed from the identify singer operation 280 to the end operation 290. Thus, the system may attribute the audio recording to a singer based on a comparison of the embedding to the plurality of reference embeddings in the embedding space.

The method 200 may terminate at the end operation 290. The end operation 290 may correspond to completion of the method 200 with respect to the audio recording. For example, the system may release resources associated with processing of the audio recording, log a result of the method 200, transmit the result to a downstream system, and/or initiate processing of a next audio recording. In some aspects, the system may perform the method 200 iteratively for a plurality of audio recordings, such that the end operation 290 with respect to a first audio recording is followed by the start operation 205 with respect to a second audio recording.

In some aspects, the method 200 may include additional operations, fewer operations, different operations, and/or differently arranged operations than those shown in FIG. 2. For example, the method 200 may include a pre-processing operation between the receive operation 210 and the classify operation 220, the pre-processing operation including application of a source separation model to isolate the vocal signal from background music contained in the audio recording, application of a voice activity detector to remove non-vocal segments from the isolated vocal signal, or both. Additionally, or alternatively, the generate embedding operation 260 may include extracting a plurality of time windows from the audio recording, generating a respective per-window embedding for each of the plurality of time windows using the singer identification model, and/or averaging the per-window embeddings to produce the embedding. Additionally, or alternatively, the classify operation 220 may include extracting a plurality of time windows from the audio recording, applying the deepfake detection model to each of the plurality of time windows to generate a respective per-window classification result, and averaging the per-window classification results to generate the classification of the audio recording.

As indicated above, FIG. 2 is provided as an example. Other examples may differ from what is described with regard to FIG. 2.

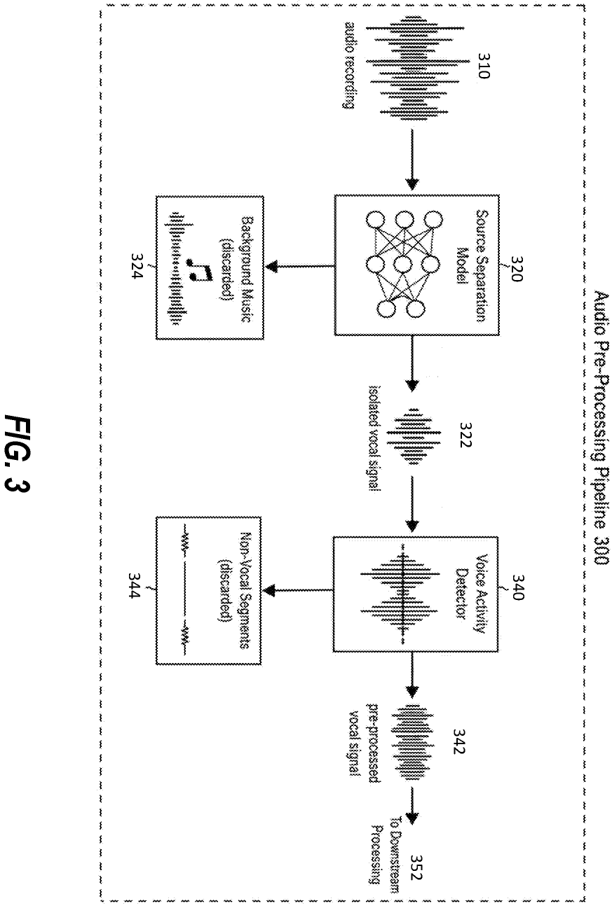

FIG. 3 illustrates an audio pre-processing pipeline 300 that processes an audio recording prior to application of a deepfake detection model, a singer identification model, or both, in accordance with aspects of the present disclosure. The audio pre-processing pipeline 300 may include a source separation model 320 and/or a voice activity detector 340. The audio pre-processing pipeline 300 may receive an audio recording 310 as input and may output a pre-processed vocal signal 342 for downstream processing. Thus, the audio pre-processing pipeline 300 may improve accuracy of downstream deepfake detection and singer identification by isolating a vocal signal from background music and removing non-vocal segments from the isolated vocal signal.

The audio pre-processing pipeline 300 may receive the audio recording 310. The audio recording 310 may be the same as or similar to the audio recording 112 of FIG. 1. For example, the audio recording 310 may include a vocal signal and background music, where the vocal signal includes a representation of a singing voice, a spoken voice, a rapping voice, a humming voice, or another type of vocal expression. In some aspects, the audio recording 310 may be received from a streaming service, a social media platform, a content delivery network, a local file system, and/or another audio source. Additionally, or alternatively, the audio recording 310 may be received as part of a batch of audio recordings to be processed by the audio pre-processing pipeline 300.

The audio pre-processing pipeline 300 may apply the source separation model 320 to the audio recording 310. The source separation model 320 may refer to a machine learning model trained to separate a vocal signal from background music contained in an audio recording. For example, the source separation model 320 may include a neural network trained on paired examples of mixed audio recordings and isolated vocal tracks. Additionally, or alternatively, the source separation model 320 may include a transformer-based architecture, a convolutional neural network, a recurrent neural network, and/or another type of neural network suitable for source separation. In some aspects, the source separation model 320 may include a band-split transformer, such as a BS-Roformer model. The source separation model 320 may output an isolated vocal signal 322 and/or a separated background music signal.

The source separation model 320 may discard the separated background music signal at a discard block 324. For example, the source separation model 320 may delete the separated background music signal, store the separated background music signal in a buffer, route the separated background music signal to a different processing pipeline, and/or otherwise prevent the separated background music signal from being processed further by the audio pre-processing pipeline 300. Thus, the audio pre-processing pipeline 300 may prevent a downstream model from learning dependencies on background music, which may improve the ability of the downstream model to focus on vocal characteristics.

The source separation model 320 may output the isolated vocal signal 322. The isolated vocal signal 322 may refer to a vocal signal from which background music has been removed by the source separation model 320. For example, the isolated vocal signal 322 may include continuous segments of vocal audio interspersed with non-vocal segments, where the non-vocal segments correspond to portions of the audio recording 310 in which the vocal signal is silent or substantially silent. The isolated vocal signal 322 may be provided as input to the voice activity detector 340.

The audio pre-processing pipeline 300 may apply the voice activity detector 340 to the isolated vocal signal 322. The voice activity detector 340 may refer to a component that detects vocal activity in an audio signal and/or identifies non-vocal segments of the audio signal. For example, the voice activity detector 340 may include an energy-based voice activity detector, a model-based voice activity detector, a spectral voice activity detector, and/or another type of voice activity detector. In some aspects, the voice activity detector 340 may include an energy-based voice activity detector that compares an energy of the isolated vocal signal 322 to a threshold to identify non-vocal segments. Additionally, or alternatively, the voice activity detector 340 may include a neural network trained to classify segments of the isolated vocal signal 322 as vocal or non-vocal.

The voice activity detector 340 may remove non-vocal segments from the isolated vocal signal 322. The non-vocal segments may refer to portions of the isolated vocal signal 322 in which a vocal signal is not present and/or is below a threshold level. For example, the voice activity detector 340 may identify non-vocal segments based on an energy threshold, a duration threshold, a spectral characteristic, a model output, and/or a combination thereof. The voice activity detector 340 may discard the non-vocal segments at a discard block 344. For example, the voice activity detector 340 may delete the non-vocal segments, store the non-vocal segments in a buffer, or otherwise prevent the non-vocal segments from being included in the pre-processed vocal signal 342. Thus, the audio pre-processing pipeline 300 may reduce computational waste by removing non-vocal segments that are irrelevant for downstream deepfake detection and/or singer identification, and may further improve accuracy of downstream models by ensuring that the downstream models operate on segments of audio that contain vocal content.

The voice activity detector 340 may output the pre-processed vocal signal 342. The pre-processed vocal signal 342 may refer to a vocal signal from which background music and/or non-vocal segments have been removed. For example, the pre-processed vocal signal 342 may include continuous segments of vocal audio without intervening non-vocal segments and without background music. In some aspects, the pre-processed vocal signal 342 may include over forty percent less audio data than the audio recording 310, based on a typical proportion of non-vocal segments in audio recordings.

The audio pre-processing pipeline 300 may provide the pre-processed vocal signal 342 to a downstream processing stage 352. The downstream processing stage 352 may include a deepfake detection model, a singer identification model, or both. For example, the downstream processing stage 352 may include the deepfake detection model 114 of FIG. 1, the singer identification model 132 of FIG. 1, or both. In some aspects, the audio pre-processing pipeline 300 may be applied to the audio recording 310 prior to application of the deepfake detection model 114 of FIG. 1. Additionally, or alternatively, the audio pre-processing pipeline 300 may be applied to the audio recording 310 prior to application of the singer identification model 132 of FIG. 1. Additionally, or alternatively, the audio pre-processing pipeline 300 may be applied to the audio recording 310 prior to application of both the deepfake detection model 114 and the singer identification model 132 of FIG. 1.

In some aspects, the audio pre-processing pipeline 300 may include additional components, fewer components, different components, or differently arranged components than those shown in FIG. 3. For example, the audio pre-processing pipeline 300 may include a resampling component that resamples the audio recording 310 to a target sampling rate, such as 16 kilohertz, prior to application of the source separation model 320. Additionally, or alternatively, the audio pre-processing pipeline 300 may include a normalization component that normalizes an amplitude of the audio recording 310 prior to application of the source separation model 320. Additionally, or alternatively, the audio pre-processing pipeline 300 may include a segmentation component that segments the pre-processed vocal signal 342 into time windows, such as time windows having a duration of approximately ten seconds, prior to provision of the pre-processed vocal signal 342 to the downstream processing stage 352.

As indicated above, FIG. 3 is provided as an example. Other examples may differ from what is described with regard to FIG. 3.

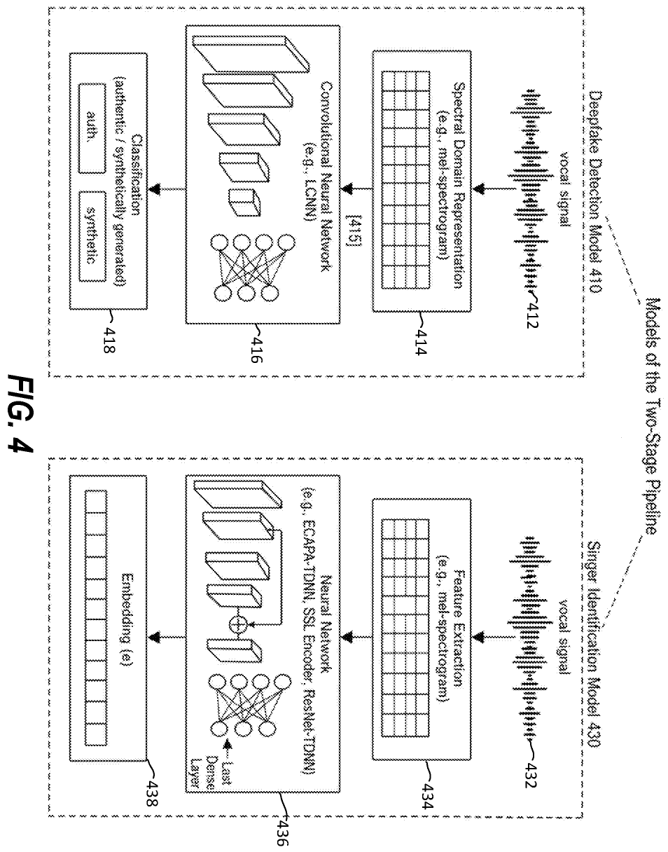

FIG. 4 illustrates an architecture of a deepfake detection model 410 and a singer identification model 430 in accordance with aspects of the present disclosure. The deepfake detection model 410 may be the same as or similar to the deepfake detection model 114 of FIG. 1. The singer identification model 430 may be the same as or similar to the singer identification model 132 of FIG. 1. The deepfake detection model 410 and the singer identification model 430 may operate as components of a two-stage pipeline, such as the two-stage pipeline 100 of FIG. 1. Thus, the deepfake detection model 410 and the singer identification model 430 may collectively support singer identification in audio recordings that contain authentic and synthetically generated vocal signals by classifying audio recordings and generating embeddings, respectively.

The deepfake detection model 410 may receive a vocal signal 412. The vocal signal 412 may be contained in an audio recording, such as the audio recording 112 of FIG. 1. For example, the vocal signal 412 may be a pre-processed vocal signal output by an audio pre-processing pipeline, such as the pre-processed vocal signal 342 of FIG. 3. Additionally, or alternatively, the vocal signal 412 may be a vocal signal extracted directly from an audio recording without pre-processing.

The deepfake detection model 410 may generate a spectral domain representation 414 of the vocal signal 412. A spectral domain representation is a representation of an audio signal in a frequency domain or a time-frequency domain. For example, the spectral domain representation 414 may include a mel-spectrogram, a short-time Fourier transform, a constant-Q transform, a wavelet transform, and/or another spectral domain representation. In some aspects, the spectral domain representation 414 may include a mel-spectrogram computed with a number of fast Fourier transform (FFT) bins, a window length, a hop length, and a number of mel bins. For example, the mel-spectrogram may be computed with 512 FFT bins, a window length of 400 samples, a hop length of 160 samples, and 80 mel bins, using a hamming window. Thus, the deepfake detection model 410 may operate on a compact spectral representation of the vocal signal 412, which reduces computational cost and improves classification accuracy by focusing the model on perceptually relevant frequency content.

The deepfake detection model 410 may apply a convolutional neural network 416 to the spectral domain representation 414. A convolutional neural network may refer to a neural network that includes one or more convolutional layers, where each convolutional layer applies a set of learned filters to an input to extract local features. For example, the convolutional neural network 416 may include a Light Convolutional Neural Network (LCNN), a residual neural network (ResNet), a VGG-style network, and/or another type of convolutional neural network. In some aspects, the convolutional neural network 416 may include an LCNN adapted for a deepfake detection task. The convolutional neural network 416 may include a sequence of convolutional layers followed by one or more dense layers.

The deepfake detection model 410 may output a classification 418 based on the convolutional neural network 416. The classification 418 may indicate that the vocal signal 412 is authentic or that the vocal signal 412 is synthetically generated. For example, the classification 418 may include a label, a probability score, a confidence score, and/or a combination thereof. In some aspects, the classification 418 may include a binary label indicating one of authentic or synthetically generated, along with a probability score indicating a confidence of the classification. Thus, the deepfake detection model 410 may filter audio recordings based on the classification 418, which improves accuracy of downstream singer identification by excluding audio recordings classified as synthetically generated from a singer identification process.

The singer identification model 430 may receive a vocal signal 432. The vocal signal 432 may be the same as or similar to the vocal signal 412. For example, the vocal signal 432 may be contained in an audio recording that has been classified as authentic by the deepfake detection model 410. In some aspects, the vocal signal 432 may be a pre-processed vocal signal output by an audio pre-processing pipeline, such as the pre-processed vocal signal 342 of FIG. 3.

The singer identification model 430 may apply a feature extraction component 434 to the vocal signal 432. The feature extraction component 434 may generate a representation of the vocal signal 432 suitable for input to a neural network. For example, the feature extraction component 434 may generate a mel-spectrogram, a log-compressed mel-spectrogram, a short-time Fourier transform, and/or another spectral or time-frequency representation. In some aspects, the feature extraction component 434 may generate a log-compressed mel-spectrogram of the vocal signal 432.

The singer identification model 430 may apply a neural network 436 to an output of the feature extraction component 434. The neural network 436 may include any neural network suitable for generating an embedding from a vocal signal. For example, the neural network 436 may include a time-delay neural network with channel attention, such as an ECAPA-TDNN. Additionally, or alternatively, the neural network 436 may include a self-supervised learning encoder, such as an EfficientNet-based encoder trained with a self-supervised learning loss. Additionally, or alternatively, the neural network 436 may include a residual network combined with a time-delay neural network, such as a ResNet-TDNN. The neural network 436 may include one or more layers, such as convolutional layers, attention layers, residual layers, recurrent layers, dense layers, or a combination thereof.

The singer identification model 430 may extract an embedding 438 from a layer of the neural network 436. The embedding 438 may be the same as or similar to the embedding 134 of FIG. 1. For example, the embedding 438 may be extracted from a last dense layer of the neural network 436. The last dense layer may refer to a fully connected layer of the neural network 436 that produces a vector representation suitable for use as the embedding 438. In some aspects, the embedding 438 may include a vector having a fixed dimensionality, such as 128 dimensions, 192 dimensions, 256 dimensions, 512 dimensions, and/or another dimensionality. The embedding 438 may be provided to a nearest-neighbor search component, such as the embedding comparison component 136 of FIG. 1, for comparison against a plurality of reference embeddings.

In some aspects, the singer identification model 430 may be trained such that embeddings generated from vocal signals of a same singer cluster more closely in an embedding space than embeddings generated from vocal signals of different singers. For example, the singer identification model 430 may be trained using an additive margin softmax loss, a contrastive loss, a triplet loss, a self-supervised learning loss that encourages clustering of embeddings from a same singer, and/or another loss function suitable for learning singer-discriminative representations. Thus, the embedding 438 may occupy a position in the embedding space that is close to positions of reference embeddings of a same singer and far from positions of reference embeddings of different singers, which supports accurate singer identification by way of nearest-neighbor search.

In some aspects, the deepfake detection model 410 and the singer identification model 430 may be trained independently of one another. For example, the deepfake detection model 410 may be trained on a first training dataset that includes authentic and synthetically generated vocal signals, and the singer identification model 430 may be trained on a second training dataset that includes vocal signals of a plurality of singers. Additionally, or alternatively, the deepfake detection model 410 and the singer identification model 430 may be trained jointly using a combined training dataset and a combined loss function. Thus, the architecture shown in FIG. 4 may accommodate independently trained or jointly trained models based on training data availability and deployment constraints.

In some aspects, the deepfake detection model 410, the singer identification model 430, or both, may include additional components, fewer components, different components, or differently arranged components than those shown in FIG. 4. For example, the deepfake detection model 410 may include a recurrent neural network, a transformer, or another type of neural network in place of or in addition to the convolutional neural network 416. Additionally, or alternatively, the singer identification model 430 may include a transformer, a graph neural network, or another type of neural network in place of or in addition to the neural network 436. Additionally, or alternatively, the spectral domain representation 414 and the feature extraction component 434 may include the same or different spectral or time-frequency representations.

As indicated above, FIG. 4 is provided as an example. Other examples may differ from what is described with regard to FIG. 4.

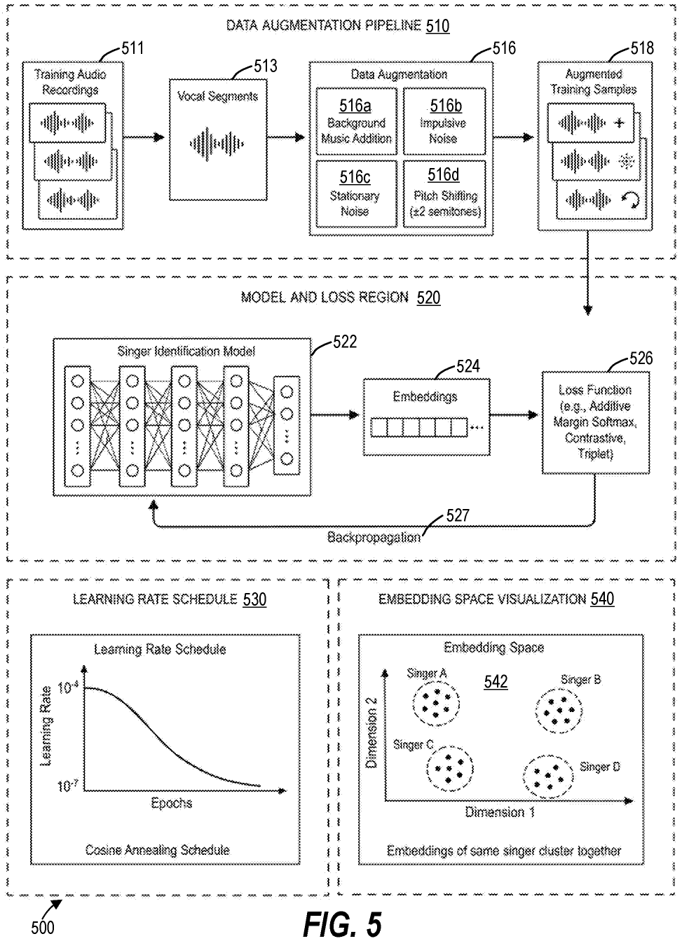

FIG. 5 illustrates a training process 500 for a singer identification model in accordance with aspects of the present disclosure. The training process 500 may be performed to train a singer identification model, such as the singer identification model 132 of FIG. 1 or the singer identification model 430 of FIG. 4, prior to deployment of the singer identification model in a two-stage pipeline, such as the two-stage pipeline 100 of FIG. 1. The training process 500 may include a data augmentation pipeline 510, a model and loss computation region 520, a learning rate schedule 530, and an embedding space property 540. Thus, the training process 500 may produce a singer identification model that generates embeddings that cluster by singer in an embedding space, which supports accurate singer identification by way of nearest-neighbor search at inference time.

The training process 500 may receive a plurality of training audio recordings 511. The plurality of training audio recordings 511 may include audio recordings of vocal signals from a plurality of singers. For example, the plurality of training audio recordings 511 may be sourced from a commercial catalogue, a publicly available dataset, a proprietary dataset, and/or a combination thereof. In some aspects, the plurality of training audio recordings 511 may include recordings featuring a single singer per recording, recordings spanning a diverse range of genres and vocal styles, or both. Additionally, or alternatively, the plurality of training audio recordings 511 may exclude classical music, may exclude recordings with multiple singers, or may include any other selection criterion suitable for the training task.

The training process 500 may extract vocal segments 513 from the plurality of training audio recordings 511. A vocal segment may refer to a portion of an audio recording that contains a vocal signal. For example, the vocal segments 513 may be extracted by applying a source separation model and a voice activity detector to the plurality of training audio recordings 511, such as the source separation model 320 and the voice activity detector 340 of FIG. 3. In some aspects, the vocal segments 513 may include continuous portions of vocal audio without intervening non-vocal segments and without background music.

The training process 500 may apply a data augmentation pipeline 510 to the vocal segments 513. The data augmentation pipeline 510 may modify the vocal segments 513 to produce augmented training samples 518. The augmented training samples 518 may refer to versions of the vocal segments 513 that have been modified by one or more augmentation operations 516. For example, the data augmentation pipeline 510 may include a background music addition operation 516a, an impulsive noise operation 516b, a stationary noise operation 516c, and/or a pitch shifting operation 516d. The data augmentation pipeline 510 may apply one or more of these augmentation operations to each vocal segment.

The data augmentation pipeline 510 may apply the background music addition operation 516a to the vocal segments 513. The background music addition operation 516a may add a random background music segment to a vocal segment. For example, the background music segment may be selected from a library of music segments, a portion of a training audio recording, and/or another source. Thus, the singer identification model may operate accurately on audio recordings that contain musical accompaniment by training on vocal segments augmented with background music.

The data augmentation pipeline 510 may apply the impulsive noise operation 516b to the vocal segments 513. The impulsive noise operation 516b may add an impulsive signal-dependent noise to a vocal segment. An impulsive signal-dependent noise may refer to a noise signal that includes short-duration, high-amplitude transients whose characteristics depend on the underlying vocal signal. For example, the impulsive signal-dependent noise may simulate clipping, popping, and/or other transient distortions that may occur in real-world audio recordings.

The data augmentation pipeline 510 may apply the stationary noise operation 516c to the vocal segments 513. The stationary noise operation 516c may add a stationary signal-independent noise to a vocal segment. A stationary signal-independent noise may refer to a noise signal whose statistical characteristics are constant, or substantially constant, over time and independent of the underlying vocal signal. For example, the stationary signal-independent noise may include white noise, pink noise, brown noise, and/or another stationary noise type.

The data augmentation pipeline 510 may apply the pitch shifting operation 516d to the vocal segments 513. The pitch shifting operation 516d may shift a pitch of a vocal segment by a number of semitones. For example, the pitch shifting operation 516d may shift the pitch of the vocal segment by a value within a range of plus or minus two semitones, plus or minus three semitones, or another suitable range. In some aspects, the data augmentation pipeline 510 may apply each augmentation operation with a probability, such as a probability of approximately thirty-five percent, to prevent the singer identification model from overfitting to specific characteristics of authentic vocal samples. Thus, the data augmentation pipeline 510 may produce augmented training samples 518 that encourage the singer identification model to develop generalized representations of singers, which improves robustness of the singer identification model to variations in real-world audio.

The training process 500 may provide the augmented training samples 518 to a singer identification model 522. The singer identification model 522 may be the same as or similar to the singer identification model 132 of FIG. 1 or the singer identification model 430 of FIG. 4. For example, the singer identification model 522 may include a time-delay neural network with channel attention, a self-supervised learning encoder, a residual network combined with a time-delay neural network, or another type of neural network suitable for generating embeddings from vocal signals. The singer identification model 522 may generate embeddings 524 based on the augmented training samples 518.

The training process 500 may compute a loss based on the embeddings 524 using a loss function 526. The loss function 526 may include any loss function suitable for training a singer identification model. For example, the loss function 526 may include an additive margin softmax loss, a contrastive loss, a triplet loss, a self-supervised learning loss, or another loss function. In some aspects, the loss function 526 may include a self-supervised learning loss that encourages clustering of embeddings from a same singer while distinguishing embeddings from different singers. Additionally, or alternatively, the loss function 526 may include an additive margin softmax loss that improves discriminative power of singer embeddings.

The training process 500 may update parameters of the singer identification model 522 based on the loss using a backpropagation operation 527. The backpropagation operation 527 may compute gradients of the loss with respect to the parameters of the singer identification model 522 and may update the parameters based on the gradients. Thus, the training process 500 may iteratively improve the singer identification model 522 by minimizing the loss over the augmented training samples 518.

The training process 500 may apply a learning rate schedule 530 to the backpropagation operation 527. A learning rate schedule may refer to a function that determines a learning rate used during training as a function of training progress. For example, the learning rate schedule 530 may include a cosine annealing schedule that starts at an initial learning rate and decays to a final learning rate over a course of training. In some aspects, the cosine annealing schedule may start at an initial learning rate of approximately 10⁻⁴ and decay to a final learning rate of approximately 10⁻⁷. Additionally, or alternatively, the learning rate schedule 530 may include a step decay schedule, a linear decay schedule, an exponential decay schedule, or another schedule. The training process 500 may further apply a weight decay during the backpropagation operation 527, such as a weight decay of approximately 10⁻⁵, to regularize the training process.

The training process 500 may train the singer identification model 522 for a number of epochs. An epoch may refer to a complete pass through the training data. For example, the training process 500 may train the singer identification model 522 for approximately 100 epochs, with an early stopping criterion based on a validation loss. In some aspects, the training process 500 may use a batch size of approximately 64 samples per training iteration. Additionally, or alternatively, the training process 500 may select a best-performing version of the singer identification model 522 based on a lowest validation loss observed during training.

The training process 500 may produce a trained singer identification model 522 that exhibits an embedding space property 540. The embedding space property 540 may include a property that embeddings generated from vocal signals of a same singer cluster more closely in an embedding space than embeddings generated from vocal signals of different singers. For example, embeddings generated from vocal signals of a first singer may form a first cluster in the embedding space 542, embeddings generated from vocal signals of a second singer may form a second cluster in the embedding space 542, and a distance between the first cluster and the second cluster may be larger than a distance between embeddings within the first cluster or between embeddings within the second cluster. Thus, the trained singer identification model 522 may support accurate singer identification by way of nearest-neighbor search at inference time, by producing embeddings whose positions in the embedding space reflect singer identity.

In some aspects, the training process 500 may include additional operations, fewer operations, different operations, or differently arranged operations than those shown in FIG. 5. For example, the training process 500 may include a pre-processing operation that resamples the plurality of training audio recordings 511 to a target sampling rate, such as 16 kilohertz, prior to extraction of the vocal segments 513. Additionally, or alternatively, the training process 500 may include a windowing operation that segments each vocal segment into time windows, such as time windows having a duration of approximately ten seconds with starting positions randomized at each iteration, prior to application of the data augmentation pipeline 510. Additionally, or alternatively, the training process 500 may train the singer identification model 522 jointly with a deepfake detection model, such as the deepfake detection model 114 of FIG. 1 or the deepfake detection model 410 of FIG. 4.

As indicated above, FIG. 5 is provided as an example. Other examples may differ from what is described with regard to FIG. 5.

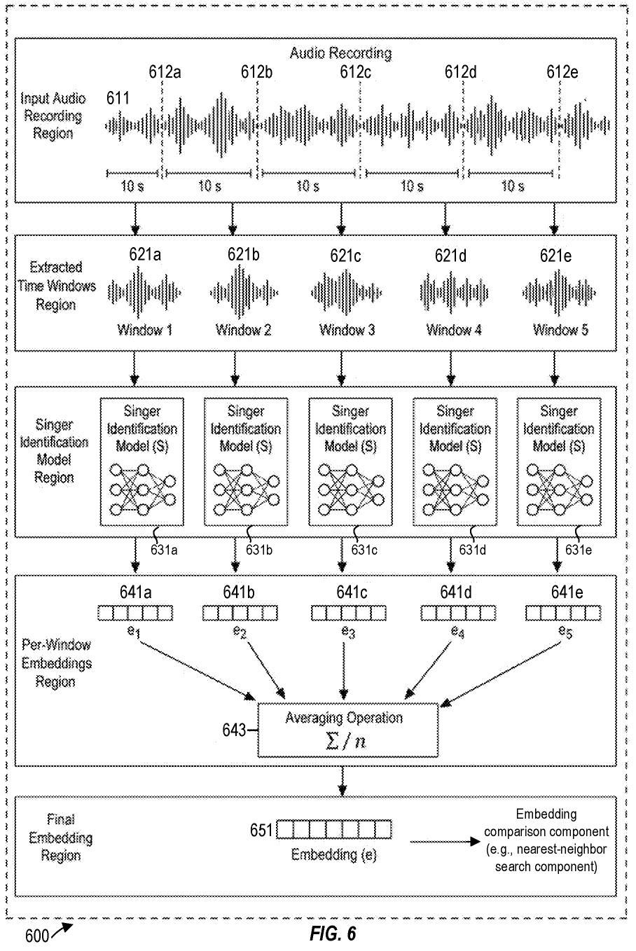

FIG. 6 illustrates a windowed inference procedure 600 in accordance with aspects of the present disclosure. The windowed inference procedure 600 may be performed by a singer identification model, such as the singer identification model 132 of FIG. 1, the singer identification model 430 of FIG. 4, or the singer identification model 522 of FIG. 5. The windowed inference procedure 600 may extract a plurality of time windows from an audio recording, generate a respective per-window embedding for each of the plurality of time windows, and average the per-window embeddings to produce an embedding for the audio recording. Thus, the windowed inference procedure 600 may produce an embedding that is more representative of the audio recording as a whole by aggregating information across multiple time windows of the audio recording, which reduces sensitivity of the embedding to local variations in the audio recording.

The windowed inference procedure 600 may receive an audio recording 611. The audio recording 611 may be the same as or similar to the audio recording 112 of FIG. 1. For example, the audio recording 611 may be an audio recording that has been classified as authentic by a deepfake detection model, such as the deepfake detection model 114 of FIG. 1 or the deepfake detection model 410 of FIG. 4. In some aspects, the audio recording 611 may be a pre-processed vocal signal output by an audio pre-processing pipeline, such as the pre-processed vocal signal 342 of FIG. 3.

The windowed inference procedure 600 may extract a plurality of time windows from the audio recording 611. A time window may refer to a contiguous portion of an audio recording having a defined duration. For example, the windowed inference procedure 600 may extract five equidistant time windows from the audio recording 611, where each time window has a duration of approximately ten seconds. Additionally, or alternatively, the windowed inference procedure 600 may extract a different number of time windows, such as three time windows, four time windows, six time windows, ten time windows, or another number of time windows. Additionally, or alternatively, each time window may have a different duration, such as five seconds, fifteen seconds, twenty seconds, or another duration. In some aspects, the plurality of time windows may be equidistant, such that the time windows are evenly spaced along a duration of the audio recording 611. Additionally, or alternatively, the plurality of time windows may overlap with one another, may be non-overlapping, or may include a combination of overlapping and non-overlapping time windows.

The windowed inference procedure 600 may identify start positions of the plurality of time windows. For example, the windowed inference procedure 600 may identify the start positions based on equidistant spacing across a duration of the audio recording 611, such as start positions 612a, 612b, 612c, 612d, and 612e. In some aspects, the windowed inference procedure 600 may identify the start positions based on a content of the audio recording 611, such as positions of vocal segments identified by a voice activity detector. Additionally, or alternatively, the windowed inference procedure 600 may identify the start positions based on randomization, periodic sampling, or another selection criterion.

The windowed inference procedure 600 may extract a plurality of extracted time windows 621a, 621b, 621c, 621d, and 621e from the audio recording 611 based on the start positions. Each of the extracted time windows 621a, 621b, 621c, 621d, and 621e may include a contiguous portion of the audio recording 611 having a duration of approximately ten seconds. The extracted time windows 621a, 621b, 621c, 621d, and 621e may be provided in parallel to a singer identification model.

The windowed inference procedure 600 may apply the singer identification model to each of the extracted time windows 621a, 621b, 621c, 621d, and 621e. The singer identification model may be the same as or similar to the singer identification model 132 of FIG. 1 or the singer identification model 430 of FIG. 4. For example, the windowed inference procedure 600 may apply the singer identification model in parallel to each of the extracted time windows by using a plurality of model instances 631a, 631b, 631c, 631d, and 631e. Each of the plurality of model instances 631a, 631b, 631c, 631d, and 631e may correspond to a same singer identification model. Additionally, or alternatively, the windowed inference procedure 600 may apply the singer identification model sequentially to each of the extracted time windows 621a, 621b, 621c, 621d, and 621e using a single model instance.

The windowed inference procedure 600 may generate a plurality of per-window embeddings 641a, 641b, 641c, 641d, and 641e based on the application of the singer identification model. A per-window embedding may refer to an embedding generated from a single time window of an audio recording. For example, the windowed inference procedure 600 may generate a first per-window embedding 641a (e₁) from the first extracted time window 621a, a second per-window embedding 641b (e₂) from the second extracted time window 621b, a third per-window embedding 641c (e₃) from the third extracted time window 621c, a fourth per-window embedding 641d (e₄) from the fourth extracted time window 621d, and a fifth per-window embedding 641e (e₅) from the fifth extracted time window 621e. Each of the plurality of per-window embeddings 641a, 641b, 641c, 641d, and 641e may include a vector of fixed dimensionality.

The windowed inference procedure 600 may apply an averaging operation 643 to the plurality of per-window embeddings 641a, 641b, 641c, 641d, and 641e. The averaging operation 643 may compute an average of the per-window embeddings to produce an embedding 651. For example, the averaging operation 643 may compute an arithmetic mean of the per-window embeddings, where each component of the embedding 651 is computed as an arithmetic mean of corresponding components of the per-window embeddings. Additionally, or alternatively, the averaging operation 643 may compute a weighted mean, a median, a trimmed mean, or another aggregation of the per-window embeddings. In some aspects, the averaging operation 643 may compute the arithmetic mean according to the formula: embedding = (e₁ + e₂ + e₃ + e₄ + e₅) / n, where n is the number of per-window embeddings. Thus, the windowed inference procedure 600 may produce an embedding 651 that aggregates information from across the plurality of time windows, which reduces sensitivity of the embedding 651 to local variations such as transient noise, momentary changes in vocal characteristics, or other localized phenomena.

The windowed inference procedure 600 may output the embedding 651. The embedding 651 may be the same as or similar to the embedding 134 of FIG. 1 or the embedding 438 of FIG. 4. The embedding 651 may include a vector of fixed dimensionality that represents an aggregated representation of features extracted from the audio recording 611 by the singer identification model. The windowed inference procedure 600 may provide the embedding 651 to a downstream component, such as a nearest-neighbor search component. For example, the embedding 651 may be provided to the embedding comparison component 136 of FIG. 1, which may compute distance metrics between the embedding 651 and a plurality of reference embeddings to identify a singer associated with the audio recording 611.

In some aspects, the windowed inference procedure 600 may apply a similar windowed inference operation to the deepfake detection task. For example, a deepfake detection model, such as the deepfake detection model 114 of FIG. 1 or the deepfake detection model 410 of FIG. 4, may extract a plurality of time windows from an audio recording, apply the deepfake detection model to each of the plurality of time windows to generate a respective per-window classification result, and average the per-window classification results to generate a classification of the audio recording. Thus, the windowed inference procedure 600 may be applied to both the deepfake detection task and the singer identification task, which reduces sensitivity of the outputs of both tasks to local variations in the audio recording by aggregating information across multiple time windows.

In some aspects, the windowed inference procedure 600 may include additional operations, fewer operations, different operations, or differently arranged operations than those shown in FIG. 6. For example, the windowed inference procedure 600 may include a pre-processing operation that applies a source separation model and a voice activity detector to the audio recording 611 prior to extraction of the plurality of time windows, such as the audio pre-processing pipeline 300 of FIG. 3. Additionally, or alternatively, the windowed inference procedure 600 may include a normalization operation that normalizes each of the per-window embeddings prior to the averaging operation 643. Additionally, or alternatively, the windowed inference procedure 600 may include a confidence weighting operation that weights each per-window embedding by a confidence score prior to the averaging operation 643.

As indicated above, FIG. 6 is provided as an example. Other examples may differ from what is described with regard to FIG. 6.

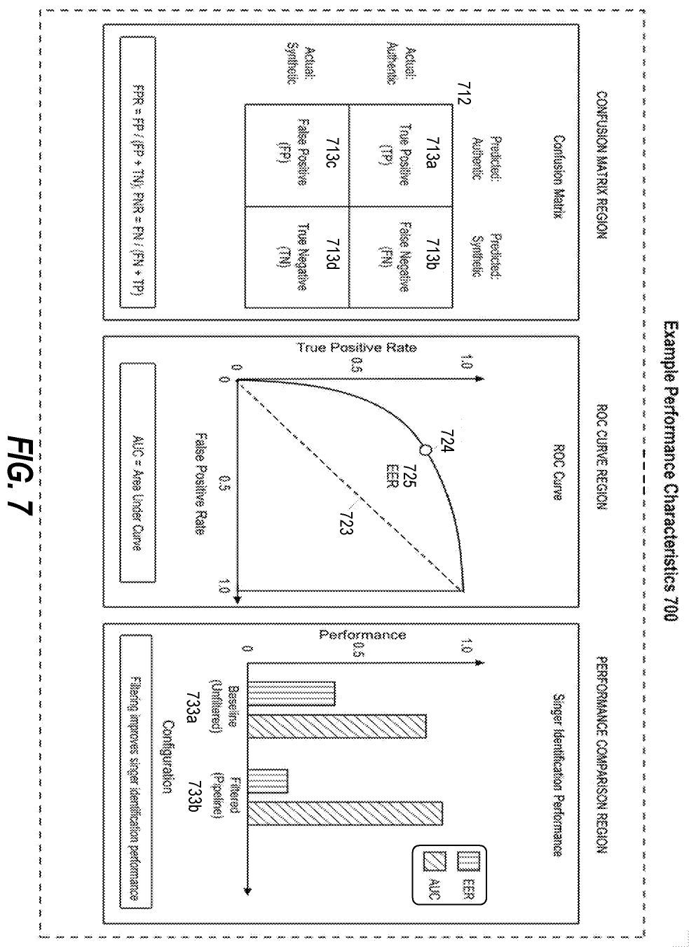

FIG. 7 illustrates example performance characteristics 700 of a deepfake detection model in accordance with aspects of the present disclosure. The deepfake detection model may be the same as or similar to the deepfake detection model 114 of FIG. 1 or the deepfake detection model 410 of FIG. 4. The performance characteristics 700 may include a confusion matrix 712, a Receiver Operating Characteristic (ROC) curve 724, and a comparison of singer identification performance between a baseline configuration and a filtered configuration. Thus, the performance characteristics 700 may illustrate a technical effect achieved by a two-stage pipeline that filters audio recordings classified as synthetically generated from a singer identification process, such as the two-stage pipeline 100 of FIG. 1.

The performance characteristics 700 may include the confusion matrix 712. A confusion matrix may refer to a tabular representation of classification outcomes for a classification model, where rows correspond to actual class labels and columns correspond to predicted class labels. For example, the confusion matrix 712 may include four cells: a true positive cell 713a corresponding to audio recordings that are authentic and that the deepfake detection model classifies as authentic, a false negative cell 713b corresponding to audio recordings that are authentic and that the deepfake detection model classifies as synthetically generated, a false positive cell 713c corresponding to audio recordings that are synthetically generated and that the deepfake detection model classifies as authentic, and a true negative cell 713d corresponding to audio recordings that are synthetically generated and that the deepfake detection model classifies as synthetically generated.

The performance characteristics 700 may include performance metrics derived from the confusion matrix 712. For example, the performance characteristics 700 may include a False Positive Rate (FPR) computed as a ratio of a number of false positives to a sum of the number of false positives and a number of true negatives. Additionally, or alternatively, the performance characteristics 700 may include a False Negative Rate (FNR) computed as a ratio of a number of false negatives to a sum of the number of false negatives and a number of true positives. In some aspects, the deepfake detection model may exhibit a low FPR across multiple datasets, indicating that authentic audio recordings are reliably classified as authentic. Additionally, or alternatively, the deepfake detection model may exhibit a comparatively higher FNR on datasets that contain high-quality synthetically generated audio recordings, indicating that some high-quality synthetically generated audio recordings may be classified as authentic. Thus, the deepfake detection model may operate with a trade-off in which audio recordings classified as authentic are highly reliable, while some synthetically generated audio recordings may pass through to a downstream singer identification process.

The performance characteristics 700 may include the ROC curve 724. A Receiver Operating Characteristic (ROC) curve may refer to a graphical representation of a classifier’s performance across a range of decision thresholds, where the horizontal axis represents a False Positive Rate and the vertical axis represents a True Positive Rate. The ROC curve 724 may extend from a lower-left corner of a graph to an upper-right corner of the graph, with a shape that bows upward and to the left of a diagonal reference line 723. The diagonal reference line 723 may represent a random-classifier baseline. For example, an ROC curve that bows further upward and to the left of the diagonal reference line 723 indicates better-than-random classification performance. In some aspects, the performance characteristics 700 may include an Area Under the Curve (AUC) metric computed as an area between the ROC curve 724 and a horizontal axis of the graph. Additionally, or alternatively, the performance characteristics 700 may include an Equal Error Rate (EER) marker 725 positioned on the ROC curve 724 at an operating point at which the False Positive Rate equals the False Negative Rate. Thus, the ROC curve 724 may characterize the performance of the deepfake detection model across a range of operating points, which supports selection of an appropriate threshold for a particular deployment.

The performance characteristics 700 may include a comparison of singer identification performance between a baseline configuration 733a and a filtered configuration 733b. The baseline configuration 733a may include a singer identification model that operates on audio recordings without filtering by a deepfake detection model. The filtered configuration 733b may include a two-stage pipeline that filters audio recordings classified as synthetically generated from a singer identification process, such as the two-stage pipeline 100 of FIG. 1. For example, the comparison may include a first performance metric, such as an Equal Error Rate (EER), and a second performance metric, such as an Area Under the Curve (AUC), computed for both the baseline configuration 733a and the filtered configuration 733b.

The filtered configuration 733b may exhibit improved performance relative to the baseline configuration 733a. For example, the filtered configuration 733b may exhibit a lower Equal Error Rate (EER) than the baseline configuration 733a. Additionally, or alternatively, the filtered configuration 733b may exhibit a higher Area Under the Curve (AUC) than the baseline configuration 733a. In some aspects, the filtered configuration 733b may exhibit an improvement in EER of more than approximately twenty percent relative to the baseline configuration 733a on a first dataset that includes authentic and synthetically generated audio recordings. Additionally, or alternatively, the filtered configuration 733b may exhibit an improvement in EER of more than approximately forty percent relative to the baseline configuration 733a on a second dataset that includes authentic and synthetically generated audio recordings. Thus, the two-stage pipeline may improve singer identification performance by filtering audio recordings classified as synthetically generated from the singer identification process, which ensures that the singer identification model operates on audio recordings that contain authentic vocal characteristics.

In some aspects, the performance characteristics 700 may be characterized across multiple datasets. For example, the performance characteristics 700 may be characterized across a first dataset that contains audio recordings of vocal signals without background music and a second dataset that contains audio recordings of vocal signals with background music. Additionally, or alternatively, the performance characteristics 700 may be characterized across a first dataset that contains lower-quality synthetically generated audio recordings and a second dataset that contains higher-quality synthetically generated audio recordings. In some aspects, the deepfake detection model may exhibit a higher False Negative Rate on the second dataset than on the first dataset, reflecting that higher-quality synthetically generated audio recordings are more likely to be classified as authentic. Thus, the performance characteristics 700 may illustrate that the two-stage pipeline reliably filters lower-quality synthetically generated audio recordings while passing higher-quality synthetically generated audio recordings to the singer identification model, which is appropriate because higher-quality synthetically generated audio recordings contain vocal characteristics suitable for processing by the singer identification model.

In some aspects, the performance characteristics 700 may include additional metrics, fewer metrics, different metrics, or differently arranged metrics than those shown in FIG. 7. For example, the performance characteristics 700 may include a precision metric, a recall metric, an F1 score, an accuracy metric, or another metric. Additionally, or alternatively, the performance characteristics 700 may include a precision-recall curve, a calibration curve, or another graphical representation of classifier performance. Additionally, or alternatively, the performance characteristics 700 may include performance metrics for the singer identification model, the deepfake detection model, or a combination thereof.

As indicated above, FIG. 7 is provided as an example. Other examples may differ from what is described with regard to FIG. 7.

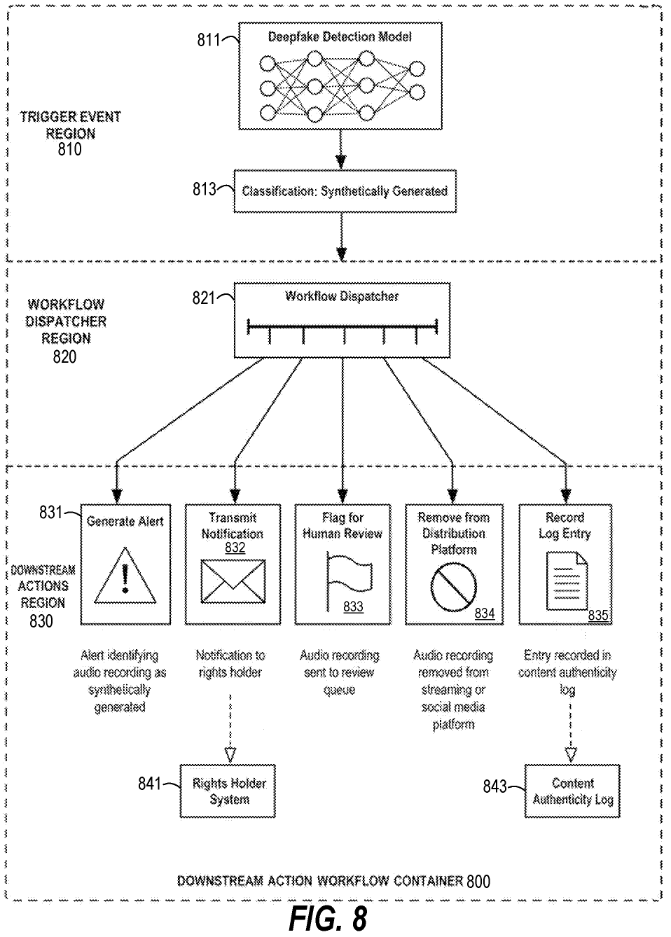

FIG. 8 illustrates a downstream action workflow 800 in accordance with aspects of the present disclosure. The downstream action workflow 800 may be initiated in response to a classification of an audio recording as synthetically generated by a deepfake detection model. The deepfake detection model may be the same as or similar to the deepfake detection model 114 of FIG. 1 or the deepfake detection model 410 of FIG. 4. The downstream action workflow 800 may include a trigger event region 810, a workflow dispatcher region 820, and a plurality of downstream actions 830. Thus, the downstream action workflow 800 may support content authenticity workflows by routing audio recordings classified as synthetically generated to one or more downstream actions, which enables a system to take appropriate action with respect to such audio recordings.

The downstream action workflow 800 may be initiated based on a classification 813 generated by a deepfake detection model 811. The classification 813 may indicate that an audio recording is synthetically generated. For example, the deepfake detection model 811 may apply a classification operation to the audio recording, such as the classify operation 220 of FIG. 2, to generate the classification 813. In some aspects, the classification 813 may be generated as part of a two-stage pipeline, such as the two-stage pipeline 100 of FIG. 1, in which audio recordings classified as synthetically generated are excluded from a singer identification process and routed to the downstream action workflow 800.

The downstream action workflow 800 may provide the classification 813 to a workflow dispatcher 821. A workflow dispatcher may refer to a component that routes a triggering event to one or more downstream actions based on a routing rule. For example, the workflow dispatcher 821 may receive the classification 813 and may select one or more downstream actions to perform based on a routing rule. The routing rule may specify which downstream actions to perform based on factors including a confidence score of the classification 813, a source of the audio recording, a content of the audio recording, a characteristic of a vocal signal contained in the audio recording, an applicable regulatory requirement, a user preference, or a combination thereof. In some aspects, the workflow dispatcher 821 may select all of the downstream actions to perform in parallel. Additionally, or alternatively, the workflow dispatcher 821 may select a subset of the downstream actions to perform based on the routing rule.

The downstream action workflow 800 may include a generate alert action 831. The generate alert action 831 may generate an alert identifying the audio recording as synthetically generated. An alert is a notification that signals an event of interest to a user, system, or process. For example, the alert may be generated as a visual notification, an audible notification, an email message, a text message, a push notification, an entry in a notification feed, or another notification format. In some aspects, the alert may identify the audio recording, identify the classification 813, identify a confidence score of the classification 813, identify a source of the audio recording, or include any combination thereof. Thus, the system may inform a user that an audio recording has been classified as synthetically generated, which supports user awareness and decision-making with respect to such audio recordings.

The downstream action workflow 800 may include a transmit notification action 832. The transmit notification action 832 may transmit a notification to a rights holder. A rights holder may refer to an entity that owns or controls rights with respect to a vocal signal contained in the audio recording. For example, the rights holder may include a recording artist, a record label, a music publisher, a performing rights organization, a management company, or another entity associated with the vocal signal. In some aspects, the transmit notification action 832 may transmit the notification to a rights holder system 841. The rights holder system 841 is a system associated with the rights holder, such as a content management system, a rights management portal, an email server, a notification service, and/or another system. The notification may include information identifying the audio recording, the classification 813, a source of the audio recording, a timestamp, or a combination thereof. Thus, the system may enable rights holders to receive timely information about audio recordings that may include unauthorized synthetic reproductions of their vocal signals, which supports rights enforcement and likeness protection.

The downstream action workflow 800 may include a flag for human review action 833. The flag for human review action 833 may flag the audio recording for review by a human reviewer. For example, the flag for human review action 833 may add the audio recording to a review queue, attach metadata to the audio recording indicating that the audio recording requires review, transmit the audio recording to a review interface, or perform another flagging operation. In some aspects, a human reviewer may evaluate the audio recording based on the flag and may determine an appropriate further action, such as confirming the classification, overriding the classification, escalating the audio recording to a different reviewer, or initiating a different workflow. Thus, the system may incorporate human judgment into the content authenticity workflow, which supports oversight of automated classifications and reduces a risk of erroneous downstream actions based on false positive classifications.

The downstream action workflow 800 may include a remove from distribution platform action 834. The remove from distribution platform action 834 may remove the audio recording from a distribution platform. A distribution platform may refer to a system that distributes audio recordings to end users, such as a streaming service, a social media platform, a content delivery network, an audio sharing service, and/or another distribution system. For example, the remove from distribution platform action 834 may delete the audio recording from the distribution platform, hide the audio recording from end users, restrict access to the audio recording, replace the audio recording with a placeholder, or perform another removal operation. Thus, the system may prevent further distribution of audio recordings that have been classified as synthetically generated, which mitigates harm associated with unauthorized synthetic reproductions of vocal signals.

The downstream action workflow 800 may include a record log entry action 835. The record log entry action 835 may record an entry in a content authenticity log. A content authenticity log may refer to a record that stores information about classifications and actions performed with respect to audio recordings. For example, the record log entry action 835 may store the entry in a content authenticity log 843. The content authenticity log 843 may include a database, a file system, a blockchain ledger, a distributed log, or another storage mechanism. The entry may include information identifying the audio recording, the classification 813, a confidence score, a timestamp, an identifier of the deepfake detection model 811, an identifier of one or more downstream actions performed, and/or a combination thereof. Thus, the system may maintain a record of classifications and downstream actions, which supports auditability, forensic analysis, regulatory compliance, and longitudinal analysis of synthetically generated audio recordings.

The downstream actions of the downstream action workflow 800 may be performed alone or in combination. For example, the workflow dispatcher 821 may select a single downstream action to perform with respect to a given audio recording. Additionally, or alternatively, the workflow dispatcher 821 may select two or more downstream actions to perform with respect to a given audio recording. In some aspects, the workflow dispatcher 821 may select different combinations of downstream actions for different audio recordings based on the routing rule. Thus, the downstream action workflow 800 may provide flexibility to accommodate different content authenticity policies, regulatory environments, and operational requirements.

In some aspects, the downstream action workflow 800 may include additional downstream actions, fewer downstream actions, different downstream actions, or differently arranged downstream actions than those shown in FIG. 8. For example, the downstream action workflow 800 may include a quarantine action that stores the audio recording in a quarantine data store for further analysis. Additionally, or alternatively, the downstream action workflow 800 may include a watermarking action that adds a watermark to the audio recording indicating that the audio recording has been classified as synthetically generated. Additionally, or alternatively, the downstream action workflow 800 may include a forensic analysis action that initiates a forensic analysis of the audio recording, the forensic analysis including identification of a synthesis method, identification of a source of the synthesis, or identification of a target vocal identity. Additionally, or alternatively, the downstream action workflow 800 may include a regulatory reporting action that transmits a report to a regulatory authority based on a regulatory requirement.

In some aspects, the downstream action workflow 800 may also be applied to audio recordings classified as authentic. For example, a separate downstream action workflow may be initiated in response to identification of a singer associated with an audio recording by a singer identification model, such as the singer identification model 132 of FIG. 1. The separate downstream action workflow may include actions such as transmitting royalty information to a rights holder associated with the identified singer, recording an entry in a content attribution log, generating an attribution credit, or performing another action based on the identified singer. Thus, the two-stage pipeline 100 of FIG. 1 may support both content authenticity workflows for audio recordings classified as synthetically generated and content attribution workflows for audio recordings classified as authentic.

As indicated above, FIG. 8 is provided as an example. Other examples may differ from what is described with regard to FIG. 8.

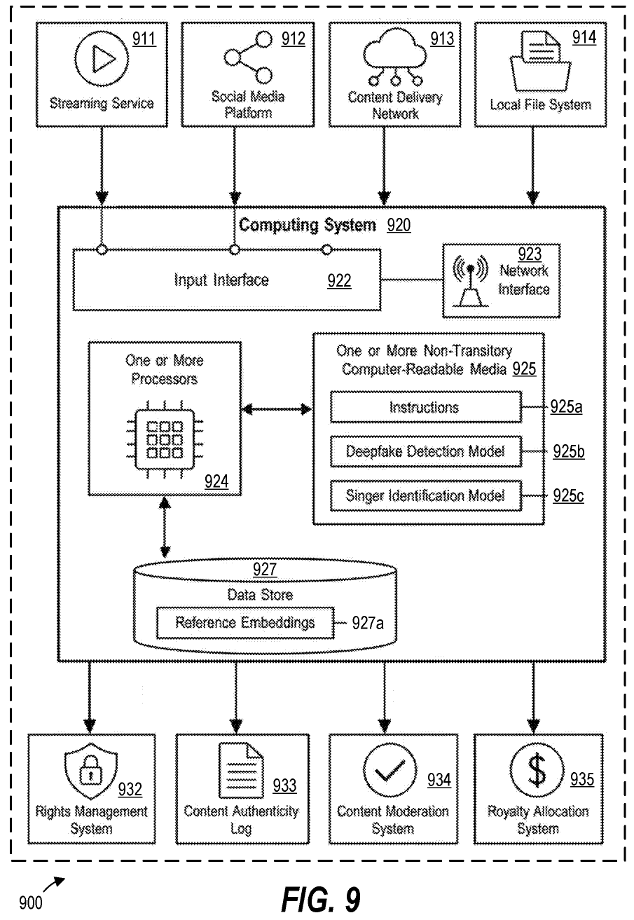

FIG. 9 illustrates a computing environment 900 in which a two-stage pipeline for singer identification can be implemented in accordance with aspects of the present disclosure. The computing environment 900 may include a computing system 920, a plurality of audio sources, and a plurality of destination systems. The computing system 920 may implement the two-stage pipeline 100 of FIG. 1 by performing operations of the method 200 of FIG. 2. Thus, the computing environment 900 may support deployment of the two-stage pipeline in a variety of contexts, including content authenticity verification, rights management, content moderation, and royalty allocation.

The computing environment 900 may include a plurality of audio sources from which audio recordings are received. An audio source may refer to a system, service, and/or storage location that provides audio recordings to the computing system 920. For example, the plurality of audio sources may include a streaming service 911, a social media platform 912, a content delivery network 913, and/or a local file system 914. A streaming service may refer to a service that distributes audio content to end users on demand, such as a music streaming service, a podcast streaming service, and/or a video streaming service that includes audio. A social media platform may refer to a platform that enables users to share content, including user-generated audio content. A content delivery network may refer to a distributed network of servers that delivers content to end users based on geographic proximity, network conditions, and/or other factors. A local file system may refer to a file system that stores audio recordings on a local storage device, such as a hard drive, a solid-state drive, a network-attached storage device, and/or another storage device. In some aspects, the plurality of audio sources may further include a microphone input, a real-time audio capture system, a podcast hosting service, an audio archive, an audio sharing service, and/or another audio source. Thus, the computing environment 900 may receive audio recordings from a wide variety of audio sources, which supports deployment of the two-stage pipeline in heterogeneous content ecosystems.

The computing system 920 may include an input interface 922. An input interface may refer to a component that receives audio recordings from one or more audio sources. For example, the input interface 922 may include a network interface, a file system interface, an application programming interface (API), a streaming interface, a message queue interface, and/or another interface suitable for receiving audio recordings. The input interface 922 may receive audio recordings from the streaming service 911, the social media platform 912, the content delivery network 913, the local file system 914, and/or a combination thereof. In some aspects, the input interface 922 may receive audio recordings as files, streams, buffers, references to remote resources, and/or other data structures.

The computing system 920 may include a network interface 923. A network interface may refer to a component that enables the computing system 920 to communicate with external systems over a network. For example, the network interface 923 may include a wired network interface, a wireless network interface, a cellular network interface, a satellite network interface, and/or another network interface. The network interface 923 may support communication using one or more network protocols, such as Transmission Control Protocol (TCP), Internet Protocol (IP), Hypertext Transfer Protocol (HTTP), Hypertext Transfer Protocol Secure (HTTPS), WebSocket, gRPC, and/or another network protocol. In some aspects, the network interface 923 may also serve as an input interface for receiving audio recordings from networked audio sources. Additionally, or alternatively, the network interface 923 may transmit outputs of the computing system 920 to networked destination systems.

The computing system 920 may include one or more processors 924. The one or more processors 924 may execute instructions to perform operations described herein. For example, the one or more processors 924 may include a central processing unit (CPU), a graphics processing unit (GPU), a tensor processing unit (TPU), a neural processing unit (NPU), a field-programmable gate array (FPGA), an application-specific integrated circuit (ASIC), a digital signal processor (DSP), or another processor type. In some aspects, the one or more processors 924 may include a combination of processor types. For example, the one or more processors 924 may include a CPU for general-purpose operations and a GPU or TPU for executing machine learning model inference. Additionally, or alternatively, the one or more processors 924 may include a plurality of processors distributed across multiple computing devices, such as a distributed computing cluster, a cloud computing environment, or a federated computing environment.

The computing system 920 may include one or more non-transitory computer-readable media 925. A non-transitory computer-readable medium may refer to a storage medium that stores instructions and data in a form that does not include transitory propagating signals. For example, the one or more non-transitory computer-readable media 925 may include a random-access memory (RAM), a read-only memory (ROM), a flash memory, a hard disk drive, a solid-state drive, an optical disk, a magnetic disk, and/or another non-transitory storage medium. In some aspects, the one or more non-transitory computer-readable media 925 may include a combination of storage media. For example, the one or more non-transitory computer-readable media 925 may include a RAM for storing data during execution and a solid-state drive for storing data persistently.

The one or more non-transitory computer-readable media 925 may store instructions 925a. The instructions 925a may include computer-executable instructions that, when executed by the one or more processors 924, cause the computing system 920 to perform operations described herein. For example, the instructions 925a may include instructions for performing the method 200 of FIG. 2, instructions for executing the deepfake detection model 114 of FIG. 1, instructions for executing the singer identification model 132 of FIG. 1, instructions for performing audio pre-processing operations of the audio pre-processing pipeline 300 of FIG. 3, instructions for performing the windowed inference procedure 600 of FIG. 6, instructions for performing the downstream action workflow 800 of FIG. 8, and/or a combination thereof.

The one or more non-transitory computer-readable media 925 may store a deepfake detection model 925b. The deepfake detection model 925b may be the same as or similar to the deepfake detection model 114 of FIG. 1 and/or the deepfake detection model 410 of FIG. 4. For example, the deepfake detection model 925b may include parameters of a trained neural network, such as weights, biases, and/or architecture specifications. The one or more processors 924 may load the parameters of the deepfake detection model 925b from the one or more non-transitory computer-readable media 925 to perform deepfake detection operations.

The one or more non-transitory computer-readable media 925 may store a singer identification model 925c. The singer identification model 925c may be the same as or similar to the singer identification model 132 of FIG. 1, the singer identification model 430 of FIG. 4, and/or the singer identification model 522 of FIG. 5. For example, the singer identification model 925c may include parameters of a trained neural network, such as weights, biases, and/or architecture specifications. The one or more processors 924 may load the parameters of the singer identification model 925c from the one or more non-transitory computer-readable media 925 to perform singer identification operations.

The computing system 920 may include a data store 927. A data store may refer to a component that stores data in a structured or unstructured form for retrieval by the computing system 920. For example, the data store 927 may include a database, a vector store, a file system, a key-value store, a document store, and/or another data storage mechanism. The data store 927 may store a plurality of reference embeddings 927a. The plurality of reference embeddings 927a may be the same as or similar to the plurality of reference embeddings 137 of FIG. 1. For example, the plurality of reference embeddings 927a may include vectors representing vocal characteristics of a plurality of singers, where each reference embedding is associated with a respective singer. In some aspects, the data store 927 may further store metadata associated with the plurality of reference embeddings 927a, such as singer names, singer identifiers, embedding generation timestamps, source recording identifiers, or other metadata.

The one or more processors 924 may exchange data with the one or more non-transitory computer-readable media 925 and the data store 927 during operation. For example, the one or more processors 924 may read instructions 925a from the one or more non-transitory computer-readable media 925, may load parameters of the deepfake detection model 925b and the singer identification model 925c from the one or more non-transitory computer-readable media 925, may read the plurality of reference embeddings 927a from the data store 927 to perform nearest-neighbor search operations, and may write outputs of operations to the one or more non-transitory computer-readable media 925, the data store 927, or both.

The computing environment 900 may include a plurality of destination systems to which outputs of the computing system 920 are provided. A destination system may refer to a system that consumes outputs of the computing system 920, such as classifications, singer identities, and/or other results of pipeline operations. For example, the plurality of destination systems may include a rights management system 932, a content authenticity log 933, a content moderation system 934, and/or a royalty allocation system 935. A rights management system may refer to a system that manages intellectual property rights with respect to audio recordings, such as licensing, attribution, and/or enforcement workflows. A content authenticity log may refer to a record that stores information about classifications and actions performed with respect to audio recordings, similar to the content authenticity log 843 of FIG. 8. A content moderation system may refer to a system that evaluates audio recordings for compliance with platform policies, regulatory requirements, and/or other criteria. A royalty allocation system is a system that allocates royalties to rights holders based on identified singers, audio recording usage, and/or other factors. In some aspects, the plurality of destination systems may further include a forensic analysis system, a regulatory reporting system, an artist notification system, a content recommendation system, and/or another destination system. Thus, the computing system 920 may provide outputs of the two-stage pipeline to a wide variety of destination systems, which supports integration of the pipeline into existing content ecosystems and operational workflows.

In some aspects, the computing environment 900 may include additional components, fewer components, different components, or differently arranged components than those shown in FIG. 9. For example, the computing system 920 may be implemented as a single computing device, such as a server, a workstation, a desktop computer, a laptop computer, a mobile device, or another computing device. Additionally, or alternatively, the computing system 920 may be implemented as a distributed computing system, such as a cluster of computing devices, a cloud computing environment, an edge computing environment, and/or a federated computing environment. Additionally, or alternatively, the computing system 920 may be implemented across multiple jurisdictions, with components hosted in different geographic locations to comply with data residency requirements, regulatory requirements, or operational requirements.

In some aspects, the components of the computing system 920 may be implemented as separate computing devices, as software modules within a single computing device, or as a combination thereof. For example, the deepfake detection model 925b and the singer identification model 925c may be implemented on separate computing devices that communicate over a network, with the deepfake detection model 925b implemented on a first computing device and the singer identification model 925c implemented on a second computing device. Additionally, or alternatively, the data store 927 may be implemented as a separate database server or as a cloud database service that is accessed by the computing system 920 over a network. Additionally, or alternatively, the input interface 922, the network interface 923, the one or more processors 924, the one or more non-transitory computer-readable media 925, and the data store 927 may be implemented as components of a single computing device.

In some aspects, the data store 927 of FIG. 9 may include a reference embedding management subsystem configured to manage a lifecycle of the plurality of reference embeddings 927a stored in the data store 927. The reference embedding management subsystem may perform operations including, by way of example and not limitation, registration of new singers, generation of reference embeddings for newly registered singers, updating of existing reference embeddings, retirement of stale reference embeddings, and detection of attempts to insert adversarial reference embeddings into the data store 927.

In some aspects, the reference embedding management subsystem may register a new singer based on receipt of a registration request from a singer, a rights holder associated with the singer, and/or another authorized entity. The registration request may include identification information associated with the singer, contact information associated with the singer or the rights holder, audio recordings of vocal performances of the singer that are usable to generate one or more reference embeddings associated with the singer, and/or any combination thereof. The reference embedding management subsystem may verify the identity of the registering entity, validate that the audio recordings included in the registration request contain authentic vocal performances of the singer (such as by applying the deepfake detection model 114 of FIG. 1 to the audio recordings), generate one or more reference embeddings based on the audio recordings, and/or store the generated reference embeddings in the data store 927 in association with the singer.

In some aspects, the reference embedding management subsystem may update one or more reference embeddings associated with a registered singer based on receipt of additional audio recordings of vocal performances of the registered singer. The reference embedding management subsystem may detect drift in vocal characteristics of the registered singer over time (including, by way of example and not limitation, drift associated with aging, vocal training, vocal injury and/or illness, stylistic evolution, and/or other factors), and may update the reference embeddings to reflect the drifted vocal characteristics. The reference embedding management subsystem may retain one or more historical reference embeddings associated with the registered singer to support identification of audio recordings that include vocal performances from earlier periods of the singer’s career.

In some aspects, the reference embedding management subsystem may retire one or more reference embeddings based on a request from a registered singer, a request from a rights holder associated with a registered singer, and/or a determination that one or more reference embeddings are no longer reliable. Retirement of a reference embedding may include removal of the reference embedding from the data store 927, marking of the reference embedding as inactive, replacement of the reference embedding with an updated reference embedding, and/or any combination thereof.

In some aspects, the reference embedding management subsystem may detect attempts to insert adversarial reference embeddings into the data store 927. An adversarial reference embedding may refer to a reference embedding that has been generated from synthetically generated audio recordings, from audio recordings that misrepresent the vocal identity of a singer, and/or that has otherwise been crafted to compromise the operation of the singer identification process. The reference embedding management subsystem may detect such attempts by applying the deepfake detection model 114 of FIG. 1 to audio recordings provided in registration requests, by comparing reference embeddings generated from registration audio recordings against existing reference embeddings to detect anomalous similarity, by validating registration requests against external identity verification systems, and/or by applying any combination of these techniques. In response to detection of an attempted insertion of an adversarial reference embedding, the reference embedding management subsystem may reject the registration request, flag the registration request for human review, transmit a notification to a rights holder associated with the impersonated vocal identity, record an entry in a content authenticity log, and/or take any combination of these actions.

In some aspects, the reference embedding management subsystem may operate continuously throughout the operational lifetime of the two-stage pipeline 100 of FIG. 1, with new reference embeddings being added, existing reference embeddings being updated, and/or stale or compromised reference embeddings being retired on an ongoing basis. The reference embedding management subsystem may maintain version history for the plurality of reference embeddings 927a to support auditability, forensic analysis, and rollback in response to detected adversarial activity.

The reference embedding management subsystem described herein is provided as a non-limiting example. Other examples may differ from the configuration described, including configurations that omit one or more of the described operations, include additional operations, or arrange the described operations differently.

As indicated above, FIG. 9 is provided as an example. Other examples may differ from what is described with regard to FIG. 9.

The following describes an example use case in which the two-stage pipeline 100 of FIG. 1 is deployed on a streaming platform to support content authenticity verification, rights management, and royalty allocation workflows in accordance with one or more embodiments. The example use case is provided for illustrative purposes and is not intended to limit the scope of the disclosure.

A streaming platform may distribute audio recordings to end users, including audio recordings uploaded by independent artists, audio recordings licensed from record labels, and audio recordings shared by users on user-generated content channels. The streaming platform may receive a continuous flow of new audio recordings each day, with each new audio recording being a candidate for distribution to end users. A subset of the new audio recordings may include synthetically generated vocal signals that replicate the vocal identity of a recording artist without authorization from the recording artist or a rights holder associated with the recording artist. The streaming platform may seek to identify such synthetically generated audio recordings before they are distributed to end users, in order to support content authenticity, protect the vocal likeness of recording artists, and ensure that royalty allocations correspond to authentic vocal performances.

The streaming platform may include a computing system, such as the computing system 920 of FIG. 9. The computing system may receive each new audio recording from an upload interface or a content ingestion pipeline of the streaming platform. The computing system may apply the two-stage pipeline 100 of FIG. 1 to the new audio recording. For example, the computing system may first apply the deepfake detection model 114 of FIG. 1 to the new audio recording. The deepfake detection model 114 may generate a classification of the new audio recording as authentic or synthetically generated.

In some aspects, the new audio recording may be classified as synthetically generated. For example, the new audio recording may include a synthetically generated vocal signal that contains audible artifacts, unrealistic spectral characteristics, or other features that the deepfake detection model 114 has been trained to detect. In response to the classification indicating that the new audio recording is synthetically generated, the computing system may initiate a downstream action workflow, such as the downstream action workflow 800 of FIG. 8. For example, the computing system may flag the new audio recording for human review, transmit a notification to a rights management team of the streaming platform, prevent the new audio recording from being distributed to end users until the human review is completed, and record an entry in a content authenticity log identifying the new audio recording, the classification, and a timestamp. A human reviewer may evaluate the new audio recording based on the flag and may determine an appropriate further action, such as confirming the classification and removing the new audio recording from the streaming platform, overriding the classification and approving the new audio recording for distribution, or escalating the new audio recording to a rights enforcement team for further investigation. Thus, the streaming platform may prevent unauthorized synthetic audio recordings from being distributed to end users, which protects the vocal likeness of recording artists and supports content authenticity.

In some aspects, the new audio recording may be classified as authentic. For example, the new audio recording may include an authentic vocal performance recorded by a recording artist, or may include a high-quality synthetic vocal signal that is sufficiently realistic to be classified as authentic by the deepfake detection model 114. In response to the classification indicating that the new audio recording is authentic, the computing system may apply the singer identification model 132 of FIG. 1 to the new audio recording. The singer identification model 132 may generate an embedding based on a vocal signal contained in the new audio recording. The computing system may compute a respective distance metric between the embedding and each of a plurality of reference embeddings stored in a data store, such as the data store 927 of FIG. 9. The plurality of reference embeddings may include reference embeddings associated with recording artists who have registered with the streaming platform, recording artists associated with rights holders who have entered into agreements with the streaming platform, or recording artists otherwise represented in a reference set maintained by the streaming platform. The computing system may identify, as a singer associated with the new audio recording, the respective recording artist whose associated reference embedding provides a smallest distance metric relative to the embedding.

In some aspects, the identified recording artist may match a recording artist credited as the performer of the new audio recording. For example, the new audio recording may have been uploaded with metadata indicating that the recording artist credited as the performer is a particular singer, and the singer identification model 132 may identify the same singer as the singer associated with the new audio recording. In response to the match, the computing system may approve the new audio recording for distribution to end users, may transmit royalty allocation information to a royalty allocation system identifying the credited recording artist, and may record an entry in a content attribution log identifying the new audio recording, the credited recording artist, and a confidence score associated with the identification. Thus, the streaming platform may verify the authenticity of credit metadata associated with new audio recordings, which supports accurate royalty allocation and reduces a risk of royalty fraud.

In some aspects, the identified recording artist may not match a recording artist credited as the performer of the new audio recording. For example, the new audio recording may have been uploaded with metadata indicating that the recording artist credited as the performer is a first singer, but the singer identification model 132 may identify a second singer, different from the first singer, as the singer associated with the new audio recording. This mismatch may indicate that the new audio recording includes a high-quality synthetic vocal signal that replicates the vocal identity of the second singer, that the new audio recording was misattributed in the upload metadata, or that the new audio recording was deliberately mislabeled. In response to the mismatch, the computing system may flag the new audio recording for human review, transmit a notification to a rights holder associated with the second singer, withhold royalty allocation pending resolution of the mismatch, and record an entry in a content authenticity log identifying the new audio recording, the credited recording artist, the identified singer, and the mismatch. Thus, the streaming platform may detect potential cases of high-quality synthetic vocal misuse that pass through the deepfake detection model 114, which extends the protection afforded by the pipeline to the most challenging synthetic audio recordings.

In some aspects, the streaming platform may apply the two-stage pipeline 100 to a backlog of audio recordings that were previously distributed to end users, in addition to applying the pipeline to new audio recordings being ingested. For example, the computing system may iterate through the backlog and may apply the pipeline to each audio recording in the backlog. The computing system may identify audio recordings in the backlog that are classified as synthetically generated and may initiate a downstream action workflow with respect to such audio recordings, such as removing them from the streaming platform or flagging them for review. Additionally, or alternatively, the computing system may identify audio recordings in the backlog whose credited recording artist does not match the singer identified by the singer identification model 132 and may initiate a downstream action workflow with respect to such audio recordings. Thus, the streaming platform may retroactively apply content authenticity protections to existing content, which extends the protection afforded by the pipeline to the platform’s full content catalog.

In some aspects, the streaming platform may further use outputs of the two-stage pipeline 100 to support recording artists in protecting their vocal likeness. For example, the streaming platform may provide an interface through which a recording artist or a rights holder associated with the recording artist may register to receive notifications when the pipeline detects audio recordings classified as synthetically generated that match the recording artist’s reference embedding. The recording artist or rights holder may then take further action with respect to such audio recordings, such as initiating a takedown request, pursuing rights enforcement, or licensing the use of the synthetic vocal signal. Thus, the streaming platform may empower recording artists and rights holders to protect their vocal likeness and to commercialize authorized synthetic uses, which addresses both the protective and commercial dimensions of vocal likeness rights.

The example use case described herein illustrates one deployment context for the two-stage pipeline 100 and is not intended to limit the scope of the disclosure. Additional, fewer, different, or differently arranged deployment contexts may be supported, including deployment on social media platforms, content delivery networks, podcast hosting services, audio archives, audio sharing services, music recognition services, forensic analysis systems, and other systems that process audio recordings.

As another illustrative and non-limiting example use case, the two-stage pipeline 100 of FIG. 1 may be deployed on a social media platform to support content moderation in accordance with one or more aspects of the present disclosure. The social media platform may host short-form video content uploaded by users, where the video content may include vocal performances. The social media platform may apply the two-stage pipeline 100 to the audio component of each uploaded video to identify videos that include synthetically generated vocal signals replicating the vocal identity of a public figure, a recording artist, or another individual whose vocal likeness is protected. In response to a classification of an audio component as synthetically generated, the social media platform may initiate a downstream action workflow that flags the video for human review, restricts distribution of the video pending review, and notifies a rights holder if the singer identification model 132 of FIG. 1 identifies a vocal likeness associated with a registered rights holder. Thus, the social media platform may support content moderation policies directed to protecting individuals from unauthorized synthetic reproductions of their vocal identity, while preserving distribution of authentic user-generated content.

In some aspects, the two-stage pipeline 100 of FIG. 1 may be replaced by, or supplemented with, alternative solution architectures that address the same technical problem of identifying a singer in an audio recording that may include a synthetically generated vocal signal. The alternative architectures described herein are non-limiting examples and are provided to illustrate the breadth of the disclosed inventive concept.

In some aspects, the disclosed approach may be implemented as a unified end-to-end neural network having a shared feature backbone, a classification head that produces an authenticity classification, and/or an embedding head that produces a singer identification embedding. The classification head and the embedding head may share one or more layers of the unified end-to-end neural network. In such an embodiment, the classification head and the embedding head may be trained jointly using a multi-task loss function that combines a deepfake detection loss and a singer identification loss. Downstream processing of the embedding output may be conditioned on the classification head output as described elsewhere herein, with binary gating, continuous-confidence weighting, or a combination thereof.

In some aspects, the disclosed approach may be implemented as a reverse-order pipeline in which the singer identification model is applied to the audio recording before the deepfake detection model. The reverse-order pipeline may generate an embedding from a vocal signal contained in the audio recording, identify a candidate singer based on the embedding and a plurality of reference embeddings, and verify the identification by comparing one or more characteristics of the audio recording (including, by way of example and not limitation, spectral characteristics, prosodic characteristics, and/or production-quality characteristics) against expected characteristics associated with the candidate singer. An inconsistency between the audio recording’s characteristics and the expected characteristics associated with the candidate singer may indicate that the audio recording includes a synthetically generated vocal signal that replicates the candidate singer’s vocal identity. The reverse-order pipeline may produce, as an output, the candidate singer identity, an authenticity assessment, or a combination thereof.

In some aspects, the disclosed approach may be implemented as an ensemble pipeline in which a plurality of deepfake detection models are applied to the audio recording in parallel, and a combined classification is generated based on outputs of the plurality of deepfake detection models. For example, the combined classification may be generated based on a majority vote, a weighted vote, an averaged confidence score, and/or another aggregation of the outputs. The plurality of deepfake detection models may include models of different architectures, models trained on different training datasets, models trained with different training procedures, or any combination thereof. The ensemble pipeline may improve detection performance on synthetically generated audio recordings produced by synthesis methods that have not been seen during training of any single model.

In some aspects, the disclosed approach may be implemented as a multi-pass pipeline in which audio recordings whose initial classification is associated with a low confidence score are re-evaluated by a different deepfake detection model, a different singer identification model, or a combination thereof. The multi-pass pipeline may identify borderline audio recordings (where the initial classification confidence is below a threshold) and may apply additional analysis to such audio recordings before producing a final classification or singer identity. The additional analysis may include applying a different model architecture, applying a different feature extraction component, applying a model trained on additional data, and/or applying human review.

In some aspects, the disclosed approach may be implemented as a multi-modal pipeline that combines audio analysis with analysis of other content modalities. For example, when the audio recording is associated with a video recording, the multi-modal pipeline may apply a visual deepfake detection model to the video recording in addition to applying the deepfake detection model to the audio recording, and may combine outputs of the visual and audio deepfake detection models to generate a combined classification. Additionally, or alternatively, the multi-modal pipeline may extract metadata associated with the audio recording (including, by way of example and not limitation, upload metadata, content provenance information, watermarking information, and/or steganographic information) and may incorporate the metadata into the classification or identification process.

Each of the alternative solution architectures described herein is provided as a non-limiting example, and any of the components, operations, or features described elsewhere in this disclosure (including but not limited to the audio pre-processing pipeline 300 of FIG. 3, the windowed inference procedure 600 of FIG. 6, the downstream action workflow 800 of FIG. 8, and the computing environment 900 of FIG. 9) may be employed with any of the alternative solution architectures described in this section.

The following definitions are provided for convenience and are not intended to limit the scope of the present disclosure. These terms should be given their broadest reasonable interpretation consistent with the context in which they appear. Where the following definitions differ from the ordinary and customary meaning of a term as understood by one of ordinary skill in the art, the definitions below are intended to supplement, not replace, that ordinary meaning. As used herein, the following terms have the meanings set forth below unless the context clearly indicates otherwise.

“Audio recording” refers to any representation of an audio signal, regardless of format, encoding, or storage medium. Audio recordings include, without limitation, time-domain representations, frequency-domain representations, time-frequency representations, compressed representations, uncompressed representations, files, streams, buffers, and/or references to remote audio resources. The term encompasses audio recordings stored on any medium, transmitted over any channel, or received in real-time, and is not limited to audio that has been finalized, mastered, or otherwise produced for distribution.

“Vocal signal” refers to a portion of an audio signal that contains a representation of a human voice. Vocal signals include, without limitation, singing voices, spoken voices, rapping voices, humming voices, scatting voices, vocalizations, vocal percussion, and combinations of two or more of these. The term encompasses vocal signals in any language, style, and/or genre, and is not limited to vocal signals that conform to any particular performance convention or musical structure. The term also encompasses vocal signals that have been processed, modified, or augmented, including vocal signals that have been pitch-shifted, time-stretched, harmonized, and/or otherwise manipulated.

“Synthetically generated” refers to any audio recording, vocal signal, or portion thereof that has been produced in whole or in part by a machine learning model, an audio synthesis algorithm, or another computational process configured to generate audio output. Synthetically generated audio recordings include, without limitation, audio recordings produced by singing voice synthesis (SVS) models, singing voice conversion (SVC) models, voice cloning models, text-to-speech models, neural vocoders, generative adversarial networks, diffusion models, autoregressive models, flow-based models, variational autoencoders, and/or hybrid architectures combining elements of two or more of these model types. The term encompasses audio recordings that have been entirely generated by such processes as well as audio recordings that have been partially generated or modified by such processes. The term is used interchangeably herein with “deepfake” and similar terms when applied to audio recordings.

“Authentic” refers to any audio recording or vocal signal that has not been synthetically generated. Authentic audio recordings include, without limitation, audio recordings of vocal performances captured by microphones, audio recordings of acoustic instruments, audio recordings of natural sounds, and/or audio recordings produced through traditional recording, mixing, and/or mastering workflows that do not include synthetic generation of vocal content. The term does not preclude conventional audio processing, such as equalization, compression, reverberation, noise reduction, and/or other processing operations that do not synthetically generate vocal content.

“Embedding” refers to a vector representation of features extracted from an input by a machine learning model, where the vector representation occupies a position in an embedding space. Embeddings include, without limitation, vectors of fixed dimensionality produced by a layer of a neural network, vectors of variable dimensionality produced by an aggregation operation across multiple layers, vectors produced by a learned projection, vectors produced by a self-supervised learning encoder, and/or vectors produced by combinations of two or more of these. The term encompasses embeddings of any dimensionality and is not limited to embeddings produced by any particular model architecture or training process.

“Embedding space” refers to a vector space in which embeddings occupy positions. The term encompasses embedding spaces of any dimensionality and is not limited to embedding spaces produced by any particular model architecture or training process. An embedding space may include structure learned during training, such that positions of embeddings within the embedding space reflect semantic, perceptual, or task-specific relationships among the inputs from which the embeddings were generated.

“Reference embedding” refers to an embedding that is associated with a known entity and that is stored for later comparison against other embeddings. Reference embeddings include, without limitation, embeddings associated with singers, embeddings associated with vocal characteristics, embeddings associated with audio recordings, and/or embeddings associated with other entities. The term is not limited to reference embeddings produced at any particular time, by any particular model, and/or under any particular training condition. Reference embeddings may be generated prior to operation of a system that uses them, may be generated continuously as new entities are registered with the system, may be updated over time as new audio recordings of registered entities become available, or any combination thereof.

“Distance metric” refers to any function that quantifies a degree of similarity or dissimilarity between two embeddings. Distance metrics include, without limitation, cosine distance, Euclidean distance, Manhattan distance, dot-product similarity, Mahalanobis distance, learned distance functions, and combinations of two or more of these. The term encompasses both distance functions in the strict mathematical sense (functions that satisfy the axioms of a metric) and/or similarity functions that quantify dissimilarity without satisfying all such axioms.

“Singer identification model” refers to a machine learning model configured to generate an embedding based on a vocal signal contained in an audio recording. Singer identification models include, without limitation, time-delay neural networks, time-delay neural networks with channel attention, residual networks, residual networks combined with time-delay neural networks, self-supervised learning encoders, transformer-based models, recurrent neural networks, convolutional neural networks, and/or hybrid architectures combining elements of two or more of these model types. The term encompasses singer identification models trained on supervised data, self-supervised data, semi-supervised data, and/or any combination thereof.

“Deepfake detection model” refers to a machine learning model configured to classify an audio recording as authentic or synthetically generated. Deepfake detection models include, without limitation, convolutional neural networks, light convolutional neural networks (LCNNs), residual networks, recurrent neural networks, transformer-based models, and/or hybrid architectures combining elements of two or more of these model types. The term encompasses deepfake detection models that operate on time-domain representations, frequency-domain representations, time-frequency representations, and/or any combination thereof.

“Source separation model” refers to a machine learning model configured to separate one or more component signals from an input audio signal. Source separation models include, without limitation, models that separate vocal signals from background music, models that separate individual instruments from a mixed audio recording, models that separate speech from noise, and/or models that separate other component signals. Source separation models include, without limitation, band-split transformer models, U-Net-based models, convolutional neural networks, recurrent neural networks, transformer-based models, and/or hybrid architectures combining elements of two or more of these model types.

“Voice activity detector” refers to a component configured to identify portions of an audio signal that contain vocal activity and portions that do not. Voice activity detectors include, without limitation, energy-based voice activity detectors, model-based voice activity detectors, spectral voice activity detectors, neural network-based voice activity detectors, and/or combinations of two or more of these. The term encompasses voice activity detectors that operate in real-time, voice activity detectors that operate on stored audio recordings, and/or voice activity detectors that operate in any combination of these modes.

“Spectral domain representation” refers to a representation of an audio signal in a frequency domain or a time-frequency domain. Spectral domain representations include, without limitation, mel-spectrograms, log-compressed mel-spectrograms, short-time Fourier transforms, constant-Q transforms, wavelet transforms, gammatone filterbank outputs, and/or combinations of two or more of these. The term is not limited to any particular spectral parameter, such as window length, hop length, number of frequency bins, and/or filterbank configuration.

“Time window” refers to a contiguous portion of an audio recording having a defined duration. Time windows include, without limitation, time windows of fixed duration, time windows of variable duration, overlapping time windows, non-overlapping time windows, equidistant time windows, non-equidistant time windows, and/or combinations of two or more of these. The term is not limited to any particular duration or selection criterion.

“Two-stage pipeline” refers to an arrangement of components in which an output of a first stage conditionally determines whether and how a second stage operates on a given input. The first stage of a two-stage pipeline includes a deepfake detection model that classifies an audio recording as authentic or synthetically generated. The second stage of a two-stage pipeline includes a singer identification model that operates on audio recordings classified as authentic by the first stage. The term does not preclude additional stages, components, or operations beyond the first stage and the second stage.

“Singer” refers to any entity associated with a vocal signal. Singers include, without limitation, individual recording artists, vocal performers, voice actors, public figures, fictional characters whose vocal performances have been recorded, and/or entities whose vocal characteristics have been captured in reference data. The term is not limited to entities who have performed in any particular musical genre, who have produced any particular type of audio recording, and/or who have entered into any particular commercial arrangement.

“Rights holder” refers to any entity that owns or controls rights with respect to a vocal signal, an audio recording, and/or a vocal identity. Rights holders include, without limitation, recording artists, record labels, music publishers, performing rights organizations, management companies, estates, heirs, licensees, and/or other entities associated with rights in vocal signals, audio recordings, and/or vocal identities. The term is not limited to entities who have registered their rights with any particular registry or who hold rights of any particular type.

“Distribution platform” refers to any system that distributes audio recordings to end users. Distribution platforms include, without limitation, streaming services, social media platforms, content delivery networks, podcast hosting services, audio sharing services, audio archives, music recognition services, video sharing services that include audio components, and combinations of two or more of these. The term is not limited to platforms that operate in any particular jurisdiction or that distribute audio recordings to any particular type of end user.

### Example Clauses

Implementation examples are described in the following numbered clauses:

Clause 1: A computer-implemented method for identifying a singer in an audio recording, the method comprising: receiving, by one or more processors, an audio recording; generating a classification of the audio recording as one of authentic or synthetically generated by applying a deepfake detection model to the audio recording; in response to the classification indicating that the audio recording is synthetically generated, excluding the audio recording from a singer identification process; and in response to the classification indicating that the audio recording is authentic: generating, using a singer identification model and based on a vocal signal contained in the audio recording, an embedding; computing a respective distance metric between the embedding and each of a plurality of reference embeddings, each reference embedding being associated with a respective singer; and identifying, as a singer associated with the audio recording, the respective singer whose associated reference embedding provides a smallest distance metric relative to the embedding.

Clause 2: The method of Clause 1, wherein the vocal signal comprises a singing voice.

Clause 3: The method of any one of Clauses 1 through 2, wherein the distance metric comprises a cosine distance.

Clause 4: The method of any one of Clauses 1 through 3, wherein the singer identification model is trained such that embeddings generated from vocal signals of a same singer cluster more closely in an embedding space than embeddings generated from vocal signals of different singers.

Clause 5: The method of any one of Clauses 1 through 4, further comprising, prior to applying the deepfake detection model, pre-processing the audio recording by applying a source separation model to isolate the vocal signal from background music contained in the audio recording.

Clause 6: The method of Clause 5, further comprising applying a voice activity detector to the isolated vocal signal to remove non-vocal segments from the isolated vocal signal.

Clause 7: The method of any one of Clauses 1 through 6, wherein the deepfake detection model comprises a convolutional neural network trained on spectral domain representations of vocal signals.

Clause 8: The method of Clause 7, wherein the spectral domain representations comprise mel-spectrogram features.

Clause 9: The method of any one of Clauses 1 through 8, wherein generating the embedding comprises: extracting a plurality of time windows from the audio recording; generating, using the singer identification model, a respective per-window embedding for each of the plurality of time windows; and averaging the per-window embeddings to produce the embedding.

Clause 10: The method of Clause 9, wherein the plurality of time windows comprises five equidistant time windows, each time window having a duration of approximately ten seconds.

Clause 11: The method of any one of Clauses 1 through 10, wherein the singer identification model comprises one of a time-delay neural network with channel attention, a self-supervised learning encoder trained on vocal signals, or a residual network combined with a time-delay neural network.

Clause 12: The method of any one of Clauses 1 through 11, wherein generating the classification comprises: extracting a plurality of time windows from the audio recording; applying the deepfake detection model to each of the plurality of time windows to generate a respective per-window classification result; and averaging the per-window classification results to generate the classification of the audio recording.

Clause 13: The method of any one of Clauses 1 through 12, wherein the deepfake detection model and the singer identification model are trained independently of one another.

Clause 14: The method of any one of Clauses 1 through 13, further comprising, in response to the classification indicating that the audio recording is synthetically generated, generating an alert identifying the audio recording as synthetically generated.

Clause 15: A processing system, comprising: a memory comprising computer-executable instructions; and a processor configured to execute the computer-executable instructions and cause the processing system to perform a method in accordance with any one of Clauses 1 through 14.

Clause 16: A processing system, comprising means for performing a method in accordance with any one of Clauses 1 through 14.

Clause 17: A non-transitory computer-readable medium storing program code for causing a processing system to perform the steps of any one of Clauses 1 through 14.

Clause 18: A computer program product embodied on a computer-readable storage medium comprising code for performing a method in accordance with any one of Clauses 1 through 14.

### Additional Considerations

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. §112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A computer-implemented method for identifying a singer in an audio recording, the method comprising:
receiving, by one or more processors, an audio recording;
generating a classification of the audio recording as one of authentic or synthetically generated by applying a deepfake detection model to the audio recording;
in response to the classification indicating that the audio recording is synthetically generated, excluding the audio recording from a singer identification process; and
in response to the classification indicating that the audio recording is authentic:
generating, using a singer identification model and based on a vocal signal contained in the audio recording, an embedding;
computing a respective distance metric between the embedding and each of a plurality of reference embeddings, each reference embedding being associated with a respective singer; and
identifying, as a singer associated with the audio recording, the respective singer whose associated reference embedding provides a smallest distance metric relative to the embedding.

2. The method of claim 1, wherein the vocal signal comprises a singing voice.

3. The method of claim 1, wherein the distance metric comprises a cosine distance.

4. The method of claim 1, wherein the singer identification model has been trained using one of an additive margin softmax loss, a contrastive loss, or a triplet loss.

5. The method of claim 1, further comprising, prior to applying the deepfake detection model, pre-processing the audio recording by applying a source separation model to isolate the vocal signal from background music contained in the audio recording.

6. The method of claim 5, further comprising applying a voice activity detector to the isolated vocal signal to remove non-vocal segments from the isolated vocal signal.

7. The method of claim 1, wherein the deepfake detection model comprises a convolutional neural network trained on spectral domain representations of vocal signals.

8. The method of claim 7, wherein the spectral domain representations comprise mel-spectrogram features.

9. The method of claim 1, wherein generating the embedding comprises:
extracting a plurality of time windows from the audio recording;
generating, using the singer identification model, a respective per-window embedding for each of the plurality of time windows; and
averaging the per-window embeddings to produce the embedding.

10. The method of claim 9, wherein the plurality of time windows comprises five equidistant time windows, each time window having a duration of approximately ten seconds.

11. The method of claim 1, wherein the singer identification model comprises one of a time-delay neural network with channel attention, a self-supervised learning encoder trained on vocal signals, or a residual network combined with a time-delay neural network.

12. The method of claim 1, wherein generating the classification comprises:
extracting a plurality of time windows from the audio recording;
applying the deepfake detection model to each of the plurality of time windows to generate a respective per-window classification result; and
averaging the per-window classification results to generate the classification of the audio recording.

13. The method of claim 1, wherein the deepfake detection model and the singer identification model are trained independently of one another.

14. The method of claim 1, further comprising, in response to the classification indicating that the audio recording is synthetically generated, generating an alert identifying the audio recording as synthetically generated.

15. A system for identifying a singer in an audio recording, the system comprising:
one or more processors; and
one or more non-transitory computer-readable media storing instructions that, when executed by the one or more processors, cause the system to perform operations comprising:
receiving an audio recording;
generating a classification of the audio recording as one of authentic or synthetically generated by applying a deepfake detection model to the audio recording;
in response to the classification indicating that the audio recording is synthetically generated, excluding the audio recording from a singer identification process; and
in response to the classification indicating that the audio recording is authentic:
generating, using a singer identification model and based on a vocal signal contained in the audio recording, an embedding;
computing a respective distance metric between the embedding and each of a plurality of reference embeddings, each reference embedding being associated with a respective singer; and
identifying, as a singer associated with the audio recording, the respective singer whose associated reference embedding provides a smallest distance metric relative to the embedding.

16. The system of claim 15, wherein the vocal signal comprises a singing voice.

17. The system of claim 15, wherein the distance metric comprises a cosine distance.

18. The system of claim 15, wherein embeddings generated from vocal signals of a same singer cluster more closely in an embedding space than embeddings generated from vocal signals of different singers.

19. The system of claim 15, the operations further comprising, prior to applying the deepfake detection model, pre-processing the audio recording by applying a source separation model to isolate the vocal signal from background music contained in the audio recording.

20. The system of claim 19, the operations further comprising applying a voice activity detector to the isolated vocal signal to remove non-vocal segments from the isolated vocal signal.

21. The system of claim 15, wherein the deepfake detection model comprises a convolutional neural network trained on spectral domain representations of vocal signals.

22. The system of claim 21, wherein the spectral domain representations comprise mel-spectrogram features.

23. The system of claim 15, wherein generating the embedding comprises:
extracting a plurality of time windows from the audio recording;
generating, using the singer identification model, a respective per-window embedding for each of the plurality of time windows; and
averaging the per-window embeddings to produce the embedding.

24. The system of claim 23, wherein the plurality of time windows comprises five equidistant time windows, each time window having a duration of approximately ten seconds.

25. The system of claim 15, wherein the singer identification model comprises one of a time-delay neural network with channel attention, a self-supervised learning encoder trained on vocal signals, or a residual network combined with a time-delay neural network.

26. The system of claim 15, wherein generating the classification comprises:
extracting a plurality of time windows from the audio recording;
applying the deepfake detection model to each of the plurality of time windows to generate a respective per-window classification result; and
averaging the per-window classification results to generate the classification of the audio recording.

27. The system of claim 15, wherein the deepfake detection model and the singer identification model are trained independently of one another.

28. The system of claim 15, the operations further comprising, in response to the classification indicating that the audio recording is synthetically generated, generating an alert identifying the audio recording as synthetically generated.

29. The system of claim 15, further comprising a data store storing the plurality of reference embeddings.
